(19) United States
(12) Patent Application Publication
(10) Pub. No.: US 2023/0013399 A1
(43) Pub. Date: Jan. 19, 2023

(54) COMPUTER IMPLEMENTED SYSTEMS AND METHODS FOR EXCHANGING DELIVERABLES

(71) Applicant: Ayman M. Mohsen, Santa Maria, CA (US)

(72) Inventor: Ayman M. Mohsen, Santa Maria, CA (US)

(21) Appl. No.: 17/950,348

(22) Filed: Sep. 22, 2022

Related U.S. Application Data
(63) Continuation-in-part of application No. 17/019,708, filed on Sep. 14, 2020.
(60) Provisional application No. 62/902,615, filed on Sep. 19, 2019.

(51) Int. Cl. G06Q 40/04; G06Q 30/06

(52) U.S. Cl. CPC G06Q 40/04; G06Q 30/0609

(57) ABSTRACT

A system for exchanging deliverables may be configured to allow a plurality of users to confidently complete transactions involving the exchange deliverables over a computer network. In preferred embodiments, the system may enable the exchange of deliverables between buyers and sellers by providing the buyer, via their client device, with a deliverable and one or more price points that each seller is willing to complete a transaction for. Preferably, each deliverable of the system will have one or more sell offers and buy offers. For buy offers with no sell offers, a recommendation engine in the system can search the internet for sellers who can offer the required deliverable. Furthermore, sold deliverables may be shipped to buyers or be kept at system warehouse. Buy or sell offers might be displayed or Hidden before execution. Some deliverables might be discounted if sold in a specific number and not just one unit.

### CROSS REFERENCE TO RELATED APPLICATIONS

This application is a continuation-in-part of U.S. Non-Provisional application Ser. No. 17/019,708, filed on Sep. 14, 2020, entitled “COMPUTER IMPLEMENTED SYSTEMS AND METHODS FOR EXCHANGING DELIVERABLES”, which claims the benefit of U.S. Provisional Patent Application No. 62/902,615, filed on Sep. 19, 2019, entitled “COMPUTER IMPLEMENTED SYSTEMS AND METHODS FOR EXCHANGING DELIVERABLES”, which is hereby incorporated by reference in its entirety.

### FIELD OF THE INVENTION

This patent specification relates to the field of exchanging deliverables, such as products and services. More specifically, this patent specification relates to computer implemented systems and methods that are configured to allow a plurality of users to complete transactions and exchange deliverables over a computer network.

### BACKGROUND

Buying and selling deliverables over the internet has always been a challenging activity for both buyers and sellers. Deliverables include goods, such as products, merchandise, gift cards, physical tickets of any kind, electronic tickets of any kind, utilities services comprising but not limited to water, gas, electricity, home phone, cell phone, cable and internet services or real estate sales, mortgage rates, broker fees, automotive rentals, purchases and leases, software and mobile applications purchase and rental and any other tangible and intangible items, and services, such as hotel reservations, air tickets reservations, any kind of ticket reservation, offers and discounts, free-lancer services, tenders, auctions, and any other offering that an individual or entity like a corporation may desire to acquire or sell.

When buyers search the internet for deliverables, such as an item, they are typically looking for a cheaper price for the item than what is available in the local stores or they are looking for an item that is not available in those local stores. However, some buyers don't have time to do an extensive search to get the best deal on their item, so they just search one of the search engines or one of the top-rated websites that are specialized in selling that item and they just buy the item at any price as long as it meets their needs. The other majority of buyers would invest some of their time to search more than one search engine in addition to specialized or general websites. They keep searching until they find the best deal, concerning price, availability, shipping rates and speed and the credibility of the seller too. Even with experienced buyers, this will take at least a good 10 minutes per item if not more.

Sellers of deliverables generally fall into one of two categories. The first category of sellers has their own website(s), which results in costs to the seller, such as overhead for maintaining the website, customer service (if available), inventory management, hired personnel for shipping and receiving returns, etc. In addition to working on getting more traffic to their website they may incur other costs including but not limited to, marketing, affiliation, blogs, etc.

The second category of sellers operate by selling through an intermediate website that have high traffic volume which will save them all the advertising hassle and bring more traffic to see their merchandise, and in return, that website will charge the seller a percentage for their service. Unfortunately, even with this kind of website, it is still frustrating for the buyers when they may find the same exact item sold by many different sellers on the same website with a considerable difference in price. Buyers always wonder if there is any real difference between the items from the different sellers that would explain the difference in pricing. The majority often go with the cheapest item, but some of the buyers do go deeper to check the shipping rates and speed, rating of the seller, customer feedback, and return policy for the seller and item when deciding which item to purchase.

Therefore, a need exists for novel systems and methods for exchanging deliverables, such as products and services, which facilitate transaction between buyers and sellers. A further need exists for novel systems and methods that are configured to allow a plurality of users to confidently complete transactions and exchange deliverables over a computer network.

### BRIEF SUMMARY OF THE INVENTION

A system for exchanging deliverables is provided. The system may be configured to allow a plurality of users to confidently complete transactions involving the exchange of deliverables over a computer network. Current online market places and e-commerce sites only allow a buyer to buy deliverable(s), via their client device, from a seller by providing the buyer with a list of deliverables provided by one or more sellers so that the buyer selects the deliverable that they desire to buy in order for the transaction to be completed between the buyer and seller, via their respective client devices. However, in preferred embodiments, the system may enable the exchange of deliverables between buyers and sellers by providing the buyer, via their client device, with a deliverable and one or more price points that each seller is willing to complete a transaction for. Similarly, in preferred embodiments, the system may enable the exchange of deliverables between buyers and sellers by providing the seller, via their client device, with a deliverable and one or more price points that each buyer is willing to complete a transaction for. In this manner, each deliverable of the system will have preferably more than one, and more preferably, a plurality, of sell offers and buy offers. Matching (execution of the transaction) may occur when a sell offer provided to the system via the client device of a seller matches (or is less than) a buy offer price provided to the system via the client device of a buyer or when a buy offer provided to the system via the client device of a buyer matches (or is more than) a sell offer price provided to the system via the client device of a seller. The buy offers and sell offers may be for a certain quantity of deliverables, such as one, two, ten, fifty, one hundred, ten thousand, or any other bulk purchase. Using their respective client devices, buyers and sellers may put more than one buy offer and more than one sell offer for the same deliverable and even in different quantities so that they might add buy offer(s) at a lower price for high quantity and sell offer(s) at a higher price for small quantity to make profit. In further embodiments, buy or sell offers can be executed by the system from more than one buyer or one seller to satisfy the requested quantity for the sell or buy offer as long as the price matches the offer.

In some embodiments, a system for exchanging deliverables may include a system database, stored in a data store, having information describing one or more deliverables and having one or more sell offers, each sell offer provided by a seller via a communication engine of a client device, and one or more buy offers, each buy offer provided by a buyer via a communication engine of a client device, for each deliverable. An execution engine, running on a computing device, may be configured to match a buy offer to a sell offer to execute a deliverable transaction in which ownership of the deliverable is transferred to the buyer and consideration is transferred to the seller via a transaction engine running on a computing device.

In further embodiments, a system for exchanging deliverables may include a system database, stored in a data store, having information describing one or more deliverables and having one or more sell offers, each sell offer provided by a seller via a communication engine of a client device, and one or more buy offers, each buy offer provided by a buyer via a communication engine of a client device, for each deliverable, in which a buy offer is received for a deliverable that does not have information stored in the system database or that does have information stored in the system but does not have current sell offers or has less than a certain number of sell offers (for example 10). A recommendation engine, running on a computing device, may be configured to search the internet to find sellers for the deliverable that does not have information stored in the system database 120, or that does have information stored in the system but does not have current sell offers or has less than a certain number of sell offers (for example 10), and configured to contact the sellers via electronic communication to solicit a sell offer for the deliverable.

In further embodiments, a system for exchanging deliverables may include a system database, stored in a data store, having information describing one or more deliverables and having one or more sell offers, each sell offer provided by a seller via a communication engine of a client device, and one or more buy offers, each buy offer provided by a buyer via a communication engine of a client device, for each deliverable. An inventory engine may be configured to determine if a deliverable is to be stored in a system warehouse 106 or to be shipped to the buyer after the completion of a transaction for the deliverable between the buyer and a seller preferably depending on buyer request or input that may be submitted during the placing or creation of the buy offer and/or later on before the warehouse 106 ships the deliverable.

In still further embodiments, a system for exchanging deliverables may include a system database, stored in a data store, having information describing one or more deliverables and having one or more sell offers, each sell offer provided by a seller via a communication engine of a client device, and one or more buy offers, each buy offer provided by a buyer via a communication engine of a client device, for each deliverable. A communication engine may be configured to display one or more buy offers and/or one or more sell offers to a user, via their client device, describing one or more deliverables. The system may also include one or more hidden buy offers and/or one or more hidden sell offers that may comprise data that may not be displayed by the communication engine. An execution engine, running on a computing device, may be configured to match a hidden buy offer to a sell offer and/or a hidden sell offer to a buy offer if a seller or buyer puts an offer that matches the hidden buy or sell offer to execute a deliverable transaction in which ownership of the deliverable is transferred to the buyer and consideration is transferred to the seller via a transaction engine running on a computing device.

In still further embodiments, a system for exchanging deliverables may include a system database, stored in a data store, having information describing one or more deliverables and having one or more sell offers, each sell offer provided by a seller via a communication engine of a client device, and one or more buy offers, each buy offer provided by a buyer via a communication engine of a client device, for each deliverable. A transaction engine, running on a computing device, may be configured to discount a deliverable of a transaction, if the sell offer for the deliverable offers a discount for one or more quantities of deliverable if one or more of the quantities of the deliverable are purchased by a buyer in the transaction.

In some embodiments, a computer implemented system and process for matching buy offers with sell offers for the transaction of deliverables is provided which may include: a system database, stored in a data store, having information describing a first deliverable; a first sell offer may be associated with the first deliverable in the system database, the first sell offer may be provided by a first seller, and the first sell offer may have a first sell offer price and a first sell offer quantity for the first deliverable; a first buy offer may be associated with the first deliverable in the system database, the first buy offer may be provided by a first buyer, the first buy offer may have a first buy offer price and a first buy offer quantity for the first deliverable; an execution engine may be configured to: compare the first buy offer price and the first buy offer quantity to the first sell offer price and the first sell offer quantity, and generate and record a deliverable transaction in which ownership of the first deliverable may be transferred to the first buyer when the first buy offer price is greater than or equal to the first sell offer price.

In some embodiments, a computer implemented system and process for matching a buy offer requesting more than one quantity with one or more sellers is provided which may include: a system database, stored in a data store, having information describing a first deliverable; a plurality of sell offers associated with the first deliverable may be stored in the system database, and the plurality of sell offers may have a plurality of sell offer prices and a plurality of sell offer quantities for the first deliverable; a first buy offer may be associated with the first deliverable in the system database, and the first buy offer specifying a first buy offer price and a first buy offer quantity for the first deliverable; and an execution engine configured to determine one or more sellers by: finding (i) a first sell offer within the plurality of sell offers with a sell offer price less than or equal to the first buy offer price and (ii) a first sell offer quantity of at least one, subtracting the first sell offer quantity from the first buy offer quantity to obtain a remaining buyer quantity; and generating and recording a deliverable transaction between the first buy offer and the first sell offer when the proceeding conditions (i) and (ii) are met.

In some embodiments, a computer implemented system and process for matching a sell offer listing more than one quantity with one or more buyers is provided which may include: a system database, stored in a data store, having information describing a first deliverable; a plurality of buy offers may be associated with the first deliverable stored in the system database, and the plurality of buy offers may have a plurality of buy offer prices and a plurality of buy offer quantities for the first deliverable; a first sell offer may be associated with the first deliverable in the system database, and the first sell offer may specify a first sell offer price and a first sell offer quantity for the first deliverable; and an execution engine configured to determine one or more buyers to match with the first sell offer by: finding (i) a first buy offer within the plurality of buy offers with a buy offer price greater than or equal to the first sell offer price and (ii) a first buy offer quantity of at least one; subtracting the first buy offer quantity from the first sell offer quantity to obtain a remaining seller quantity; and generating and recording a deliverable transaction between the first buy offer and the first sell offer when the proceeding conditions (i) and (ii) are met.

In further embodiments, a computer implemented system running on a server computer having a processor for executing a process for matching buy offers with sell offers for the transaction of deliverables is provided. The system may include a system database, stored in a data store, having information describing a first deliverable. A first sell offer may be associated with the first deliverable in the system database, the first sell offer provided by a first seller, and the first sell offer having a first sell offer price and a first sell offer quantity for the first deliverable. A first buy offer may be associated with the first deliverable in the system database, the first buy offer provided by a first buyer, and the first buy offer having a first buy offer price and a first buy offer quantity for the first deliverable. An execution engine may be running on the server, and the execution engine may be configured to cause the processor of the server to: compare the first buy offer price and the first buy offer quantity to the first sell offer price and the first sell offer quantity, and generate and record a deliverable transaction in the system database in which ownership of the first deliverable is transferred to the first buyer when the first buy offer price is greater than or equal to the first sell offer price, when the first buy offer quantity is equal to or less than the first sell offer quantity, when no other buy offer associated with the first deliverable having a higher buy offer price exists in the system database, and when no other buy offer associated with the first deliverable having an equal price and a date and time prior to the first buy offer exists in the system database.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system for exchanging deliverables according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram illustrating some software modules of a system for exchanging deliverables which may function as software rules engines according to various embodiments described herein.

FIG. 5 illustrates a block diagram of an example method for enabling a user to provide information for a deliverable and add a buy or sell offer to the system according to various embodiments described herein.

FIG. 6 depicts a block diagram of an example method of getting information describing one or more sellers from a buyer or by searching search engines and using scrapping service according to various embodiments described herein.

FIG. 7-FIG. 7 shows a block diagram of an example method of contacting one or more sellers according to various embodiments described herein.

FIG. 8 illustrates a block diagram of an example method of searching for seller(s) over the internet, contacting seller and registering a seller with the system according to various embodiments described herein.

FIG. 9 depicts a block diagram of an example method of completing a deliverable transaction according to various embodiments described herein.

FIG. 10 shows a block diagram of an example method of posting offers in the system according to various embodiments described herein.

FIG. 11 illustrates a block diagram of an example method of completing a transaction for a buy offer of a single deliverable according to various embodiments described herein.

FIG. 12 depicts a block diagram of an example method of completing a transaction of a buy offer for a quantity of a deliverable according to various embodiments described herein.

FIG. 13-FIG. 13 shows a block diagram of an example method of completing a transaction for a sell offer of a single deliverable according to various embodiments described herein.

FIG. 14 illustrates a block diagram of an example method of completing a transaction of a sell offer for a quantity of a deliverable according to various embodiments described herein.

FIG. 15 depicts a block diagram of an example method of adding a deliverable and/or sell offer to the system according to various embodiments described herein.

FIG. 16 shows a block diagram of an example method of completing a one way buy for a deliverable according to various embodiments described herein.

FIG. 17 illustrates a block diagram of an example method of determining a deliverable location post transaction according to various embodiments described herein.

FIG. 18 depicts a block diagram of an example method of processing a transaction based on the number of users associated with one or more users of the system according to various embodiments described herein.

FIG. 19 shows a graphical representation of users associated with other users in the system database according to various embodiments described herein.

FIG. 20 illustrates a block diagram of some example data records of an example system database according to various embodiments described herein.

FIG. 21 depicts a block diagram of an example process for matching a buy offer requesting more than one quantity with one or more sellers according to various embodiments described herein.

FIG. 22 illustrates a block diagram of an example process for matching a sell offer listing of a deliverable with more than one quantity with one or more buy offers according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer implemented systems and methods for exchanging deliverables are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

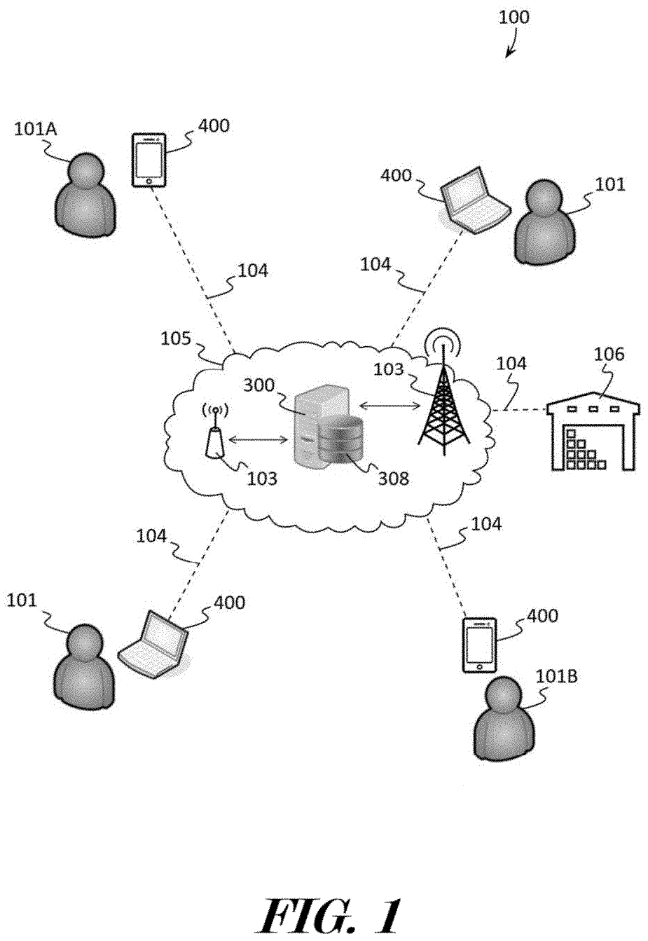

The present invention will now be described by example and through referencing the appended figures representing preferred and alternative embodiments. As perhaps best shown by FIG. 1, an illustrative example of some of the physical components which may comprise a system for exchanging deliverables (“the system”) 100 according to some embodiments is presented. The system 100 is configured to facilitate the transfer of data and information between one or more access points 103, client devices 400, and servers 300 over a data network 105. A data store 308 accessible by the server 300 may contain one or more databases. Each client device 400 may send data to and receive data from the data network 105 through a network connection 104 with an access point 103. The data may comprise any information that one or more users 101 desire to input into the system 100 including information describing one or more users 101, information describing the actions of one or more users 101, information requested by one or more users 101, information supplied by one or more users 101, information describing one or more deliverables, information describing transactions of deliverables between users 101, financial information, and any other information which a user 101 may desire to input or enter into the system 100 or may desire to extract or get out from the system 100.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

The system 100 is configured to allow a plurality of users 101 to confidently complete transactions involving the exchange deliverables over a computer network 105. Users 101 may comprise system administrators and any other individual or entity that may be allowed to access and/or modify data of the system 100. Users 101 may also include one or more, such as a plurality of buyers 101A and sellers 101B. Generally, a buyer 101A may comprise an individual, organization, entity, etc., that desires to acquire ownership and/or possession of a deliverable by providing consideration, and a seller 101B may comprise an individual, organization, entity, etc., that desires to relinquish ownership and/or possession of a deliverable by receiving consideration.

Deliverables (sometimes called “products” or “items”) may include goods, such as products, merchandise, gift cards, physical tickets of any kind, electronic tickets of any kind, utilities services comprising but not limited to water, gas, electricity, home phone, cell phone, cable and internet services, real estate sales, mortgage rates, broker fees, automotive rentals, purchases and leases, software and mobile applications purchase and rental and any other tangible and intangible items, and services, such as hotel reservations, air tickets reservations, any kind of ticket reservation, offers and discounts, free-lancer services, tenders, auctions, and any other offering that an individual may desire to acquire or sell. Consideration is something of value given by a buyer 101A in exchange for something of value given by a seller 101B. Typically, the thing of value provided to the seller 101A by the buyer 101B is currency, including digital currencies, however, it may be anything of value including goods, an act, or even another deliverable.

Current online market places and e-commerce sites only allow a buyer 101A to buy deliverable(s), via their client device 400, from a seller 101B by providing the buyer 101A with a list of deliverables provided by one or more sellers 101B so that the buyer 101A selects the deliverable that they desire to buy in order for the transaction to be completed between the buyer 101A and seller 101B, via their respective client devices 400. However, in preferred embodiments, the system 100 may enable the exchange of deliverables between buyers 101A and sellers 101B by providing the buyers 101A, via their client device 400, with a deliverable and one or more price points that each seller 101B is willing to complete a transaction for. Furthermore, in preferred embodiments, the system 100 may enable the exchange of deliverables between buyers 101A and sellers 101B by providing the sellers 101B, via their client device 400, with a deliverable and one or more price points that each buyer 101A is willing to pay to complete a transaction. In this manner, each deliverable of the system 100 will have preferably more than one, and more preferably, a plurality, of sell offers and buy offers. Matching (execution of the transaction) may occur when the sell offer price of a sell offer provided to the system 100 via the client device 400 of a seller 101B matches (or is less than) a buy offer price provided to the system 100 via the client device 400 of a buyer 101A or when a buy offer provided to the system 100 via the client device 400 of a buyer 101A matches (or is more than) a sell offer price provided to the system 100 via the client device 400 of a seller 101B. The buy offers and sell offers may be for a certain number of deliverable units, such as one, two, ten, fifty, one hundred, ten thousand, or any other bulk purchase. Using their respective client devices 400, buyers 101A and sellers 101B may put more than one buy offer and more than one sell offer for the same item and even in different quantities so that they might add a buy offer having a lower buy offer price and a greater buy offer quantity and a sell offer at higher sell offer price and a lesser sell offer quantity to make profit. In further embodiments, buy or sell offers can be executed by the system 100 from more than one buyer 101A or seller 101B to satisfy the requested quantity for the sell or buy offer as long as the price matches the offer.

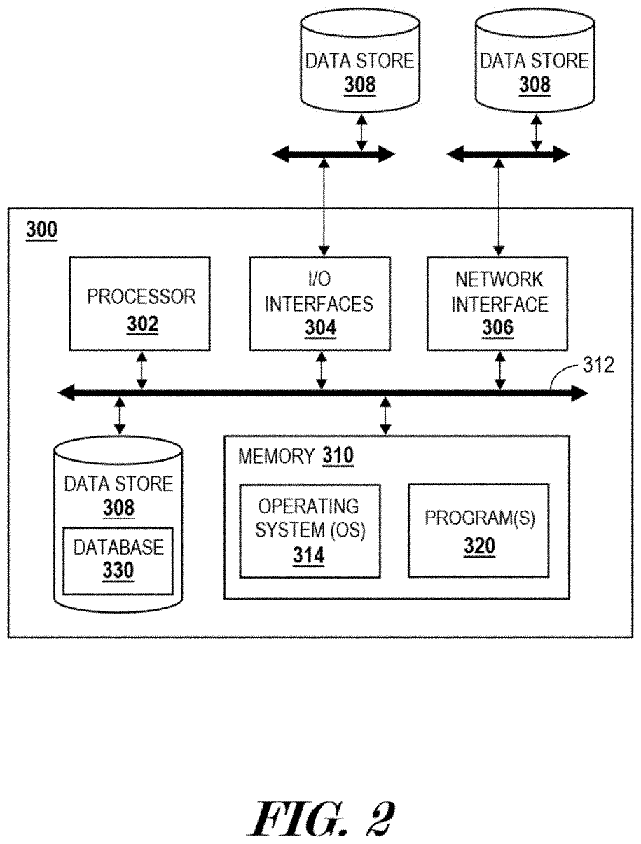

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network.

A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server. Preferably, the system 100 may comprise a system database 330 which may be stored in one or more data stores 308.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

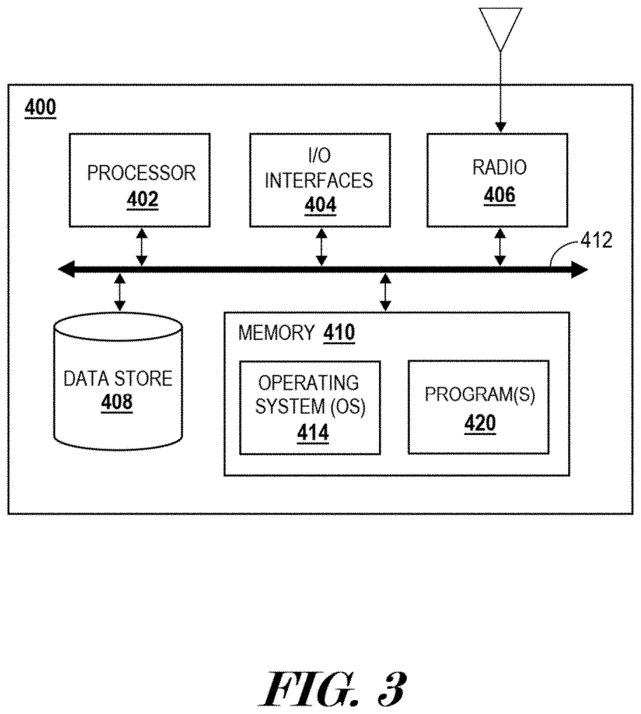

Referring to FIG. 3, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); Z-Wave wireless communications protocol used primarily for home automation; IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, a user 101 typically uses one or more of the programs 420 along with a network 105 to exchange information with the system 100.

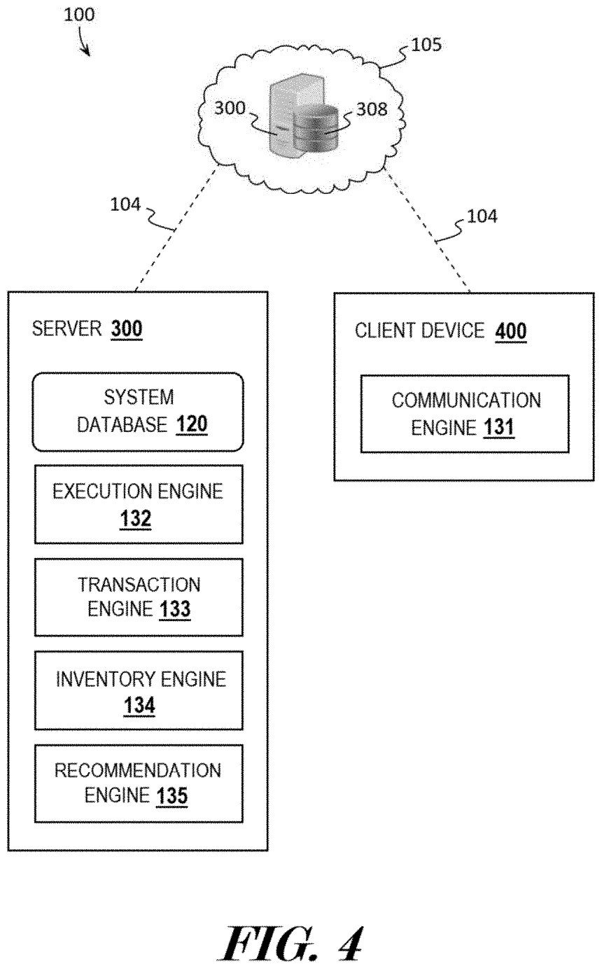

FIG. 4 depicts a block diagram showing some software rules engines which may be found in a system 100 and which may optionally be configured to run on a server 300 and/or a client device 400 according to various embodiments described herein. In some embodiments, one or more servers 300 may be configured to run one or more software rules engines or programs such as an execution engine 132, a transaction engine 133, an inventory engine 134, and/or a recommendation engine 135. In this embodiment, the engines 132, 133, 134, 135, are configured to run on at least one server 300. The server 300 may be in electronic communication with a data store 308 comprising a database, such as a system database 120. The engines 132, 133, 134, 135, may read, write, or otherwise access data in the system database 120 of the data store 308. Additionally, the engines 132, 133, 134, 135, may send and receive data to and from one or more client devices 400 which may be in wired and/or wireless electronic communication with a server 300 through a network 105.

In some embodiments, one or more client devices 400 may be configured to run one or more software rules engines or programs such as a communication engine 131. In other embodiments, a communication engine 131, execution engine 132, a transaction engine 133, an inventory engine 134, and/or a recommendation engine 135 may be configured to run on a client device 400 and/or server 300 with data transferred to and from one or more servers 300 in communication with a database of a data store 308 through a network 105. It should be understood that the functions attributed to the engines 131, 132, 133, 134, 135, described herein are exemplary in nature, and that in alternative embodiments, any function attributed to any engine 131, 132, 133, 134, 135, may be performed by one or more other engines 131, 132, 133, 134, 135, or any other suitable processor logic.

The system 100 may comprise one or more databases, such as a system database 120 stored on a data store 308 accessible to the one or more engines 131, 132, 133, 134, 135. In some embodiments, a system database 120 may comprise information that one or more users 101 desire to input into the system 100 including information describing one or more users 101, information describing the actions, such as transactions, buy offers, and sell offers, of one or more users 101, information requested by one or more users 101, information supplied by one or more users 101, information describing one or more deliverables, such as product information and descriptions, location, storage, and shipping information, information describing transactions of deliverables between users 101, and any other information which may be generated by users 101 operating the system 100.

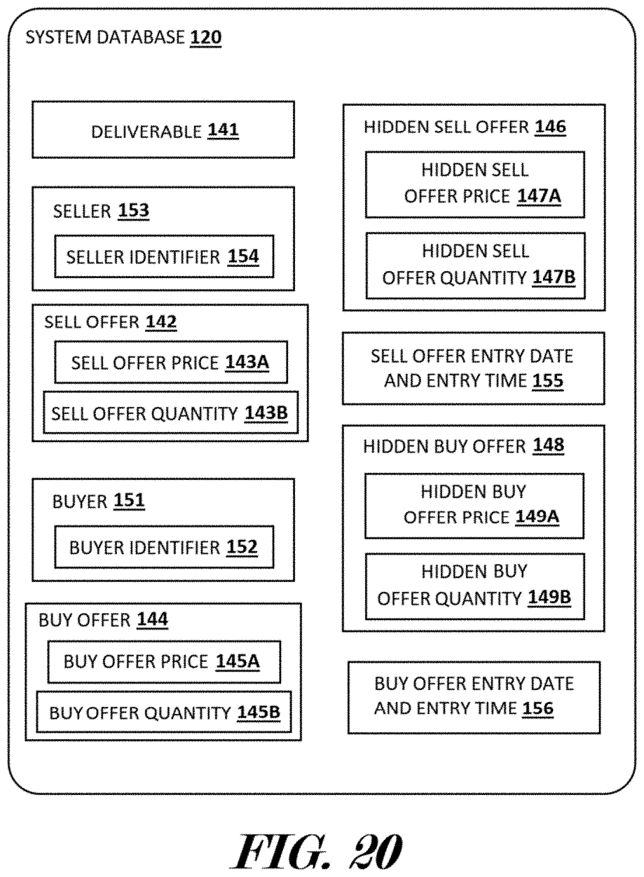

An example of a system database 120 is shown in FIG. 20 and illustrates some exemplary data records that a system database 120 may include. It should be understood that the described structure of the system database 120 is exemplary in nature, and that in alternative embodiments, the data contained within the system database 120 may be organized in any other way.

In some embodiments, a system database 120 may comprise one or more, and more preferably a plurality of deliverable data records 141. Each deliverable data record 141 may contain data describing a deliverable, such as its name, dimensions, time frame, specifications, qualifications, and/or any other data which may be used to identify and describe a specific deliverable.

The system database 120 may also comprise one or more buyer data records 151 and seller data records 153. Generally, a buyer data record 151 may comprise any information that may describe a buyer 101A of the system 100, including sort number/ranking/rating of the buyer 101A, shipping locations, a buyer identifier data record 152, etc. A buyer identifier data record 152 may comprise data describing a particular buyer 101A which may allow the system 100 users 101 of the system 100 to identify the buyer 101A so that the buyer identifier data record 152 may be unique to the buyer 101A. For example, a buyer identifier data record 152 may comprise a user name, avatar, or the like. Generally, a seller data record 153 may comprise any information that may describe a seller 101B of the system 100, including sort number/ranking/rating of the seller 101B, shipping locations, a seller identifier data record 154, etc. A seller identifier data record 154 may comprise data describing a particular seller 101B which may allow the system 100 users 101 of the system 100 to identify the seller 101B so that the seller identifier data record 154 may be unique to the seller 101B. For example, a seller identifier data record 154 may comprise a user name, avatar, or the like. Since buyers 101A may also function as sellers 101B and vice versa, data from a buyer data record 151 optionally may be the same or similar to data from a seller data record 153 for a particular user 101. For example, a buyer identifier data record 152 and seller identifier data record 154 may be the same for a particular user 101, or a user 101 may have one or more different buyer data records 151, buyer identifier data record 152, seller data records 153, and/or seller identifier data records 154.

In some embodiments, a seller 101B may choose to not have their seller identifier of their seller identifier data record 154 displayed with a sell offer of a sell offer data record 142 that they provided to the system 100 when the system 100 displays the available sell offers and/or buy offers for a particular deliverable in response to a query submitted by a user 101 for the particular deliverable. For example, a communication engine 131 may be configured to display one or more sell offers for a deliverable to a user 101 when the user 101 submits a query to the system 100 for the deliverable, and the communication engine 131 may be configured to not display the seller identifier of a sell offer based on input received from the seller 101B that created the buy offer.

Likewise, and in some embodiments, a buyer 101A may choose to not have their buyer identifier of their buyer identifier data record 152 displayed with a buy offer of a buy offer data record 144 that they provided to the system 100 when the system 100 displays the available sell offers and/or buy offers for a particular deliverable in response to a query submitted by a user 101 for the particular deliverable. For example, a communication engine 131 may be configured to display one or more buy offers for a deliverable to a user 101 when the user 101 submits a query to the system 100 for the deliverable, and the communication engine 131 may be configured to not display the buyer identifier of a buy offer based on input received from the buyer 101A that created the buy offer.

In this manner, the system 100 may enable one or more sellers 101B to request (optionally by paying a fee) to have their name undisclosed in the sell offers results table so that different sellers 101B do not know which seller 101B is placing the sell offer and the buyers 101A likewise do not know who is putting which offer. This anonymity can also be requested by a buyer 101A when they create a buy offer so that all sellers 101B responding have their names undisclosed. As an example, a company (acting as a buyer 101A) needs a huge job done and put all the specifications/requirements into a buy order and they need to get the lowest price. This company will create a buy offer as they need the service done, the contractors or people who can do the job (acting as sellers 101B) will add their offers and the original company may choose the one with the lowest price so that there is no bias (This example is for service not goods). Similarly, the system 100 may be used by freelancers where people who need a job done (buyers 101A), will post a job request (as a buy offer) and they may request that all sellers 101B have their name undisclosed (no bias). Similarly, this can be applied to all kinds of deliverables that may include goods, such as products, merchandise, gift cards, physical tickets of any kind, electronic tickets of any kind, utilities services comprising but not limited to water, gas, electricity, home phone, cell phone, cable and internet services or real estate sales, mortgage rates, broker fees, automotive rentals, purchases and leases, software and mobile applications purchase and rental and any other tangible and intangible items, and services, such as hotel reservations, air tickets reservations, any kind of ticket reservation, offers and discounts, free-lancer services, tenders, auctions, and any other offering that an individual or entity like a corporation may desire to acquire or sell.

A system database 120 may further comprise one or more sell offer data records 142 and/or one or more buy offer data records 144 which may be associated with a deliverable data record 141. A sell offer data record 142 may contain data describing a sell offer input into the system 100 by a seller 101B, such as a sell offer price data record 143A and quantity of deliverable being offered for sale (the sell offer quantity 143B data record) in the sell offer. A sell offer price data record 143A may comprise a monetary amount or other consideration that the seller 101B is willing to accept in exchange for the quantity of deliverable 143B being offered for sale in the sell offer 142. A buy offer data record 144 may contain data describing a buy offer input into the system 100 by a buyer 101A, such as a buy offer price data record 145A and the quantity of deliverable being sought for purchase (the buy offer quantity 145B data record) in the buy offer. A buy offer price data record 145A may comprise a monetary amount or other consideration that the buyer 101A is willing to provide in exchange for the quantity 145B of deliverable being sought for purchase in the buy offer 144.

In some embodiments, a system database 120 may further comprise one or more hidden sell offer data records 146 and/or one of more hidden buy offer data records 148 which may be associated with a deliverable data record 141. A hidden sell offer data record 146 may contain data similar to a sell offer data record 142, such as a hidden sell offer price data record 147A and/or a hidden sell offer quantity data record 147B. A hidden sell offer price data record 147A may comprise a monetary amount or other consideration that the seller 101B is willing to accept in exchange for the quantity 147B of deliverable being offered for sale in the hidden sell offer 146. In some embodiments, a hidden sell offer data record 146 may contain data that identifies to one or more communication engines 131 that data of the hidden sell offer data record 146 (therefore the sell offer itself) should not be displayed when users submit a query to the system 100 for the deliverable. In further embodiments, a hidden sell offer data record 146 may contain data that identifies to one or more communication engines 131 that the hidden sell offer price data record 147A and/or the hidden sell offer quantity data record 147B of the hidden sell offer data record 146 should not be displayed when users submit a query to the system 100 for the deliverable. In further embodiments, a hidden sell offer data record 146 may contain data that identifies to one or more communication engines 131 that the seller identifier 154 of the seller 101B associated with the hidden sell offer 146 should not be displayed when users submit a query to the system 100 for the deliverable. In this manner, the system 100 may enable hidden sell offers 146: which are not returned in search results to users 101; which the seller identifier 154 of the seller 101B of the sell offer 146 are not returned in search results to users 101; and/or which the price 147A of the deliverable of the sell offer 146 are not returned in search results to users 101 and/or which the quantity 147B of the deliverable of the sell offer 146 are not returned in search results to user 101.

As an example of hidden sell offers 146 enabled by the system 100, the system 100 may comprise a first sell offer 142 associated with a first deliverable 141. The first sell offer 142 may be provided by a first seller 101B via a communication engine 131 of a first client device 400, and the first sell offer 142 may have a first sell offer price 143A for the first deliverable 141. A first buy offer 144 may also be associated with the first deliverable 141. The first buy offer 144 may be provided by a first buyer 101A via a communication engine 131 of a second client device 400, and the first buy offer 144 may have a first buy offer price 145A for the first deliverable 141. A hidden sell offer 146 may also associated with the first deliverable 141. The hidden sell offer 146 may be provided by a second seller 101B (optionally the second seller 101B and first seller 101B may be the same or different people, companies, entities, etc.) via a communication engine 131 of a third client device 400, the hidden sell offer 146 may have a hidden sell offer price 147A for the first deliverable 141, and the hidden sell offer price 147A may be less than and/or equal to and/or greater than the first sell offer price 143A. A communication engine 131 may be configured to display the first buy offer 144 and the first sell offer 142 to a user 101, via a fourth client device 400, when the user 101 submits a query to the system 100 for the first deliverable 141, however, the hidden sell offer 146 and/or the hidden sell offer price 147A and/or the hidden sell offer quantity 147B and/or the seller identifier 154 may not be displayed to the user 101 based on input received from the second seller 101B when the user 101 submits a query to the system 100 for the first deliverable 141. An execution engine 132 may be configured to match the hidden sell offer 146 to the first buy offer 144 to execute or create a deliverable transaction in which ownership of the first deliverable 141 is transferred to the first buyer 101A and consideration is transferred to the second seller 101B via a transaction engine 133 running on a computing device.

A hidden buy offer data record 148 may contain data similar to a buy offer data record 144, such as a hidden buy offer price data record 149A and a hidden buy offer quantity data record 149B. A hidden buy offer price data record 149A may comprise a monetary amount or other consideration that the buyer 101A is willing to pay in exchange for the quantity 149B of deliverable being sought to be bought in the hidden buy offer 148. In some embodiments, a hidden buy offer data record 148 may contain data that identifies to one or more communication engines 131 that the data of the hidden buy offer data record 148 (therefore the buy offer itself) should not be displayed when users submit a query to the system 100 for the deliverable. In further embodiments, a hidden buy offer data record 148 may contain data that identifies to one or more communication engines 131 that the hidden buy offer price data record 149A and/or the hidden buy offer quantity data record 149A of the hidden buy offer data record 148 should not be displayed when users submit a query to the system 100 for the deliverable. In further embodiments, a hidden buy offer data record 148 may contain data that identifies to one or more communication engines 131 that the buyer identifier 152 of the buyer 101A associated with the hidden buy offer 148 should not be displayed when users submit a query to the system 100 for the deliverable. In this manner, the system 100 may enable hidden buy offers 148: which are not returned in search results to users 101; which the buyer identifier 152 of the buyer 101A of the buy offer 148 are not returned in search results to users 101; and/or which the price 149A of the deliverable of the buy offer 148 are not returned in search results to users 101 and/or which the quantity 149B of the deliverable of the buy offer 148 are not returned in search results to user 101.

As an example of hidden buy offers 148 enabled by the system 100, the system 100 may comprise a first sell offer 142 associated with a first deliverable 141. The first sell offer 142 may be provided by a first seller 101B via a communication engine 131 of a first client device 400, and the first sell offer 142 may have a first sell offer price 143A for the first deliverable 141. A first buy offer 144 may also be associated with the first deliverable 141. The first buy offer 144 may be provided by a first buyer 101A via a communication engine 131 of a second client device 400, and the first buy offer 144 may have a first buy offer price 145A for the first deliverable 141. A hidden buy offer 148 may also be associated with the first deliverable 141. The hidden buy offer 148 may be provided by a second buyer 101A (optionally the second buyer 101A and first buyer 101A may be the same or different people, companies, entities, etc.) via a communication engine 131 of a third client device 400, the hidden buy offer 148 may have a hidden buy offer price 149A for the first deliverable 141, and the hidden buy offer price 149A may be more than and/or equal to and/or less than the first buy offer price 145A. A communication engine 131 may be configured to display the first buy offer 144 and the first sell offer 142 to a user 101, via a fourth client device 400, when the user 101 submits a query to the system 100 for the first deliverable 141, however, the hidden buy offer 148 and/or the hidden buy offer price 149A and/or the hidden buy offer quantity 149B and/or the buyer identifier 152 may not be displayed to the user 101 based on input received from the second buyer 101A when the user 101 submits a query to the system 100 for the first deliverable 141. An execution engine 132 may be configured to match the hidden buy offer 148 to the first sell offer 142 to execute or create a deliverable transaction in which ownership of the first deliverable 141 is transferred to the second buyer 101A and consideration is transferred to the first seller 101B via a transaction engine 133 running on a computing device 400.

In some embodiments, the system database 120 may also comprise a sell offer entry date and entry time data record 155 which may be associated with each sell offer 142, 146. Generally, a sell offer entry date and entry time data record 155 may comprise data which may describe the date and time at which a sell offer 142, 146, was received and/or made active in the system 100. In preferred embodiments, the sell offer entry date and entry time 155 for each sell offer 142, 146, may be used by the execution engine 132 to determine the earliest sell offer 142, 146, received by the system 100, and the execution engine 132 may then match the earliest received sell offer 142, 146, to a buy offer 144, 148, if more than one sell offer prices 143A, 147A, of two or more sell offer 142, 146, are equal.

In some further embodiments, the system database 120 may also comprise a buy offer entry date and entry time data record 156 which may be associated with each buy offer 144, 148. Generally, a buy offer entry date and entry time data record 156 may comprise data which may describe the date and time at which a buy offer 144, 148, was received and/or made active in the system 100. In preferred embodiments, the buy offer entry date and entry time 156 for each buy offer 144, 148, may be used by the execution engine 132 to determine the earliest buy offer 144, 148, received by the system 100, and the execution engine 132 may then match the earliest received buy offer 144, 148, to a sell offer 142, 146, if more than one buy offer prices 145A, 149A, of two or more buy offer 144, 148, are equal.

In preferred embodiments, each client device 400 of the system 100 may comprise a communication engine 131 which may be configured to govern electronic communication between the client device 400, database(s) 120, and server(s) 300. In some embodiment, a communication engine 131 may provide a user interface on the client device 400 of a user 101 that may be suitable for receiving user input, such as buy offers and sell offers, and displaying or otherwise providing system output to the user 101. In further embodiments, the communication engine 131 may control the radio 406 of a client device 400 to send and receive data to and from one or more data stores 308, client devices 400, and other servers 300 through a network connection 104 (FIG. 1) over a network 105 (FIG. 1).

The system 100 may comprise an execution engine 132 which may be configured to run on a server 300 and/or client device 400. In some embodiments, an execution engine 132 may be configured to match one or more buy offers with one or more sell offers or vice versa for deliverables of the system 100. An execution engine 132 may match the offers (execution of the transaction) when a sell offer(s) matches or is/are less than a buy offer(s) price or when a buy offer(s) matches or is/are more than a sell offer(s) price. In further embodiments, an execution engine 132 may match one or more hidden offers, such as hidden buy offers 148 and/or hidden sell offers 146, to execute a transaction (generate and record a deliverable transaction). In further embodiments, an execution engine 132 may be configured to compare the a buy offer price 145A and a buy offer quantity 145B of a buy offer 144 for a deliverable 141 to a sell offer price 143A and a sell offer quantity 143B of a sell offer 142 for the deliverable 141, and the execution engine 132 may generate and record a deliverable transaction in which ownership of the deliverable 141 is transferred to the buyer 101A of the buy offer 144 when the buy offer price 145A is greater than or equal to the sell offer price 143A.

In further preferred embodiments, an execution engine 132 may generate and record a deliverable transaction in the system database 120 in which ownership of a deliverable 141 is transferred from a seller 101B that entered a sell offer 142, 146, for that deliverable 141 into the system 100 to a buyer 101A that entered a buy offer 144, 148, for that deliverable 141 into the system 100 when one or more, such as all, of the following conditions exist: when the buy offer price 145A, 149A, of the buy offer 144, 148, is greater than or equal to the sell offer price 143A, 147A, of the sell offer 142, 146; when the buy offer quantity 145B, 149B, is equal to or less than the sell offer price 143A, 147A, of the sell offer 142, 146; when no other buy offer 144, 148, associated with the deliverable 141 having a higher buy offer price exists 145A, 149A, in the system database 120; and/or when no other buy offer 144, 148, associated with the deliverable 141 has an equal price 145A, 149A, and a date and time prior to the buy offer 144, 148, exists the system database 120.

In some embodiments, an execution engine 132 may apply one or more discounts, that a seller 101B may offer to a buyer 101A, such as when a seller 101B creates a sell offer that has a price that decreases when a certain number of items are sold with or without a limited time frame for the sell offer. In further embodiments, an execution engine 132 may be configured to discount the sell offer price of a sell offer for a deliverable if the sell offer includes a discount to the sell offer price for a quantity of the deliverable, the quantity greater than one, if the quantity of the deliverable purchased by the buyer in the transaction is greater than one. For example, a seller 101B may offer an item (deliverable) for sale via a sell offer and advertise in that sell offer that: if the seller 101B sells more than 100 units of the item, then he will offer a certain discount, if the seller 101B sells more than 500 units of the item then he will offer higher discount; and if the seller 101B sells more than 1000 units of the item then he will offer an even higher discount. The seller 101B may provide information describing the discounts and the threshold of deliverables that must be sold for the discount to be applied, and an execution engine 132 may then discount the sell offer price for the deliverable as the number of deliverables sold reaches each discount threshold.

The system 100 may comprise a transaction engine 133 which may be configured to run on a server 300 and/or client device 400. In some embodiments, a transaction engine 133 may hold currency including digital currencies, however, it may be anything of value including goods, an act, or even another deliverable or funds of one or more users 101, such as by holding money from credit card or having money stored in a wallet of the user 101. In further embodiments, a transaction engine 133 may transfer funds to a seller 101B to a buyer 101A according to a deliverable transaction or execution. In still further embodiments, a transaction engine 133 may transfer funds to or from third party financial institutions, payment processors, etc.

The system 100 may comprise an inventory engine 134 which may be configured to run on a server 300 and/or client device 400. In some embodiments, an inventory engine 134 may be configured to input and output information to and from the system database 120 describing deliverables 141 of the system 100 to process queries for deliverable by users 101. In further embodiments, an inventory engine 134 may be configured to determine where a deliverable 141 is to be located or shipped upon the execution of a deliverable transaction, such as if a deliverable is to remain in its current location or is to be shipped to a new location upon the execution of a deliverable transaction. In still further embodiments, an inventory engine 134 may access, create, and/or modify information describing deliverables in the system database 120. In further embodiments, once a deliverable transaction for a deliverable 141 is generated and recorded by an execution engine 132, the deliverable 141 may be physically or digitally transferred to the buyer 101A by the inventory engine 134 so that the deliverable 141 may no longer be stored within the system 100. In further embodiments, once a deliverable transaction for a deliverable 141 is generated and recorded by an execution engine 132, the deliverable 141 may be digitally stored within the system database 120 or physically stored within a system warehouse 106 and the buyer data record 151 and a seller data record 153 may be updated to reflect the transfer of ownership of the deliverable 141 without having to move the deliverable 141.

The system 100 may comprise a recommendation engine 135 which may be configured to run on a server 300 and/or client device 400. In some embodiments, a recommendation engine 135 may receive search criteria from a user 101 that describes a deliverable desired by the user 101, and recommendation engine 135 may search the information describing the deliverables of the system 100 that may be stored in the system database 120 and return one or more matching deliverables of the system 100 to the user 101. In further embodiments, a recommendation engine 135 may receive search criteria from a user 101 that describes a deliverable desired by the user 101, and recommendation engine 135 may search the internet (through other e-commerce websites or search engines) to find one or more sellers for that specific item or deliverable. The recommendation engine 135 may then contact the one or more sellers found from the previous step (user 101) via electronic communication (such as via email, text message, phone call, or other means) to solicit a sell offer for the deliverable from the sellers. If the sellers are sellers 101B of the system 100, then the recommendation engine 135 may contact the sellers 101B via the communication engine 131 of their client device 400, to inform the user 101 about the buying/selling opportunity so that they can either match the buy offer or submit a counter sell offer.

The engines 131, 132, 133, 134, 135 may enable users 101 to complete transactions with deliverables. In preferred embodiments, the system 100 may store information on each deliverable in a system database 120. For each same exact deliverable sold by many sellers 101B, the system 100 may provide a single webpage or deliverable result page or table that will show all the offers from all the sellers 101B for that deliverable. The system 100 may enable the sellers 101B to see each other's offers so that they may start to compete for buyers 101A by decreasing the price of their deliverable to be the lowest price so that they sell first and sell more. In this manner, the system 100 may differ from existing e-commerce systems, having the traditional regular buying of an advertised item for a specific price, by providing a stock market like operation, where for each deliverable of the system 100 will have sell offers and buy offers preferably in the same screen or webpage. Matching (execution of the transaction) may occur when a sell offer matches a buy offer price or vice versa. This can be applied to one or more quantities. In some embodiments, for buyer 101A to enter a buy offer requires holding money from credit card or having money stored at the website in the wallet.

In some embodiments, the system 100 may enable a user 101 to link or associate two or more buy orders together via Order Cancel Order (OCO). By using OCO, a buyer 101A may place a first buy offer 144 for a deliverable 141 (item or service) then they may put another buy offer 144 (or any number of buy offers 144) for the same or a completely different deliverable 141, the user 101 may provide input to the system 100 to link or associate the two or more buy offers 144 together so that if one of the buy offers 144 is executed (matching the first buy offer 144 to a sell offer 142 and creating a deliverable transaction), the other buy offers 144 will be cancelled or deleted approximately instantaneously by the execution engine 132. The buyer 101A may do this for any number of buy offers 144 as may be allowed by the system 100. So, for example, if he has five buy offers 144 linked together by OCO, when one of the buy offers 144 is executed all the other linked buy offers 144 will be cancelled or deleted approximately instantaneously. In this manner, the system 100 may comprise a first buy offer 144 and a second buy offer 144 that may be associated with the first buy offer 144 which may both be provided by a buyer 101A via a communication engine 131 of a client device 400, and an execution engine 132 may be configured to delete the second buy offer 144 upon matching the first buy offer 144 to a sell offer 142 to execute or create a deliverable transaction.

Furthermore, these buy offers may be linked to a credit card verification, other payment method, or to money actually held from his payment method or wallet. If buyer 101A wants to put more than one buy offer for one or more deliverables he can either hold more money from credit card (or wallet) or use Order Cancel Order (OCO) so that he uses the same held money to put more than one buy offer but as soon as one buy offer is accepted and executed, all the other buy offers linked by OCO may be deleted.

In some embodiments, a buyer 101A may have two or more buy offers in the system 100 which may be for the same deliverable (associated with the same deliverable in the system database 120) and which may be associated together via OCO. In some embodiments, a buyer 101A may have two or more buy offers in the system 100 which may be for two or more deliverables (associated with two or more different deliverables in the system database 120) and which may be associated together via OCO. For example, a buyer 101A may select a number of different deliverables (for example, five different deliverables) and once he selects the deliverables, these deliverables may be added to a system shopping cart or the like or just to an extra screen that has the selected deliverables, where he can go there and add buy offers (or just prices) next to all of the selected deliverables at once by adding the price he chooses for each deliverables (all in one screen) and once he clicks ‘submit’ or the like, the system 100 will add a buy offer for each deliverable with the price that the buyer 101A chose in the previous screen and link them together automatically via OCO, instead of the buyer 101A having to individually add a buy offer, then another buy offer, then another buy offer, etc., and linking them all together via OCO.

A wholesaler seller 101B (or a regular seller 101B) may be willing to sell large quantity of a deliverable for a lower price as well as selling small quantities or even just one piece of the same deliverable at a higher price. For this reason, sellers 101B may have to define a different price for different quantities of deliverables offered. Then, when buyers 101A search for a deliverable via the system 100, they may input the exact quantity they need from that deliverable and the system 100 may bring them the search results showing all the offers available from one or more sellers 101B for this defined quantity. For example, a first seller 101B may be offering deliverable X for $20 per piece if a buyer 101A wishes to buy just one piece. On the other hand, the same seller 101B may place an offer to sell the deliverable for $7 each if the MOQ (Minimum Ordering Quantity) of a buy offer is 1000 pieces. Buyers 101A who wish to buy one piece of this deliverable may only be shown the price of $20, while other buyers 101A, such as distributers or middle agents, placing a search criterion for a MOQ of 1000 pieces will be provided with the $7 price by the system 100.

Buyers 101A or sellers 101B can put more than one buy and/or more than one sell offer for the same deliverable and even in different quantities. For example, a user 101 may add a buy offer at a lower price for high quantity of deliverable and a sell offer at lower quantity of deliverable for higher price to make profit. In further embodiments, the system 100 may enable buy or sell offers to be executed from more than one buyer 101A or seller 101B to satisfy the requested deliverable quantity for the sell or buy offer as long as the price matches the offer.

In some embodiments, the communication engine 131 may display information for each seller 101B of a deliverable which may be used by a buyer 101A to determine which seller 101B to purchase deliverables from. For example, if a seller 101B keeps their deliverables at their warehouses, next to their offers there may be few symbols indicating the following: Rating (score out of 5); Shipping options (USPS, UPS, and FedEx) including if they offer free shipping or next day delivery, etc.; Age on the system 100; Warranty period (if applicable); and Returns: accepted on not, period allowed for returns, free or not. As another example, if a seller 101B keeps their deliverables stocked at a warehouse 106 operated by the system 100, next to their offers there may be a symbol which means that this item is stocked and shipped by the system 100. This will be a major selling point as it increases the credibility of the item, this may indicate that the item may: Ship for free if its value is higher than a certain value; Be covered by free returns within 14 days of receipt or any other time period set by the system 100; Be checked before being listed and shipped by the system 100 so the buyer 101A can be totally confident that he will get exactly what he saw in the item specs and not something different or used or lower grade.

In some embodiments, the inventory engine 134 may determine the location of deliverables before and after transactions are completed. This may enable a buyer 101A to be able to select that a deliverable that they purchased may be kept stocked for him at a system warehouse 106 and not sent immediately to a location provided by the buyer 101A. The buyer 101A may then request that the deliverable be sent to him or to another destination and/or someone else at a later time. The buyer 101A may also request that the deliverable be listed in one or more sell offers at a price and quantity desired by the buyer 101A so that the buyer 101A of that deliverable may now be or function as a seller 101B of the deliverable.

Preferably, the system 100 may provide one or more methods for a buyer 101A to purchase a deliverable. In some embodiments, if a buyer 101A likes the lowest price for a deliverable, they can just go ahead and place their order using a credit card or other payment method so that they get the desired price available at that time. In further embodiments, a buyer 101A may filter the deliverable results of the system 100 to only show offer from sellers 101B that have a certain minimum rating or a certain minimum number of sales or who would ship using a certain company or a certain time frame, etc. In still further embodiments, a buyer 101A may also filter results to offers from sellers 101B from a certain geographical region or with free shipping or certain return policy, etc. In still further embodiments, and this would be the most appealing point to buyers which will alleviate any uncertainty about the sellers credibility (as mentioned above), they can filter their search to items only stocked by the system 100 in system warehouses 106. In alternative embodiments, buyers 101A may open an account in the system 100 and deposit funds in it, the same way they will do with a broker. They may place a bid price for one or more deliverables. Buyers 101A in this category may change their bid price as many times as they can as long as they have enough funds in their account, the same way buyers do in stock market. All the bids from different buyers for the same exact deliverable may be shown on the same screen together by the system 100 with all the offers from all sellers. If a seller 101B determines that a buyer's price is acceptable, the seller 101B may decrease his price to match that buyer's 101A price and the execution engine 132 may finalize the deal or transaction. On the other hand, if a buyer 101A sees that a seller's 101B price is reasonable for him, he may raise his bid to match the sellers price and the execution engine 132 may finalize the deal as long as he have enough fund in his account. Additionally, buyers 101A and sellers 101B can choose certain sell or buy offers to specifically execute without raising or decreasing their offer prices, and optionally without even adding a buy or sell offer.

In some embodiments, the system 100 may enable buyers 101A and sellers 101B to create buy and sell offers that may be hidden or not displayed to one or more users 101 of the system 100. For example, a seller 101B may be willing to sell his deliverable at a lower price than the lowest priced sell offer displayed by the system 100, but for some reason does not want to make that offer public, so they may place the sell offer at a lower price than the lowest offered price sell order but the offer may not be displayed to one or more users 101. Preferably, only if a buyer 101A tries to place a bid above the highest bid available and they meet the price of the hidden sell offer of the seller 101B, the execution engine 132 may completed the transaction. On the other hand, a buyer 101A may be willing to pay a little bit more for a deliverable but still hopes that that the lower price he placed in the bid would be met, so he may place a hidden bid that will only be met if a seller 101B decreases the price of a deliverable to meet that hidden price.

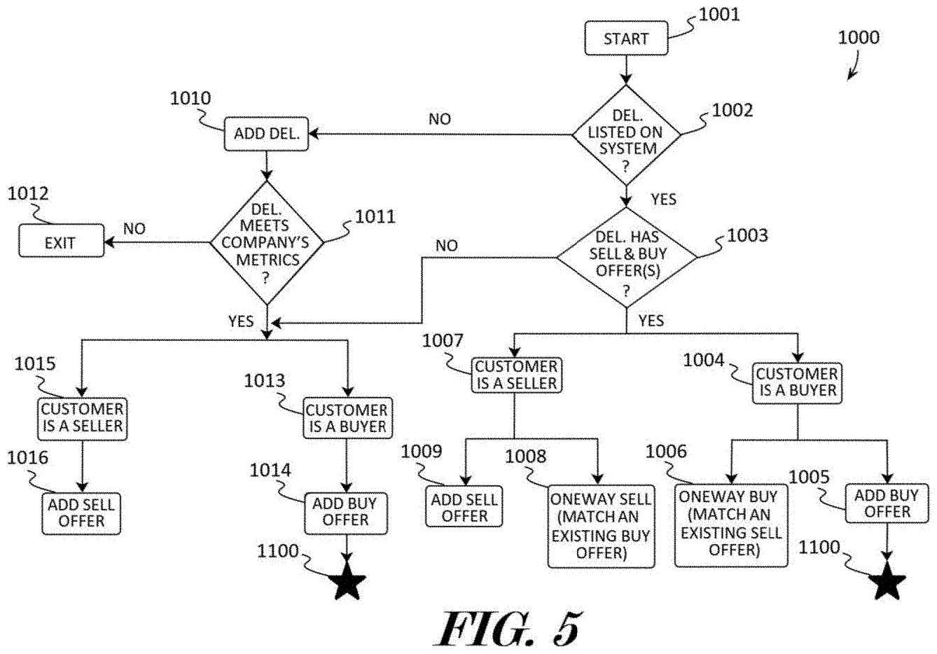

FIG. 5 illustrates a block diagram of an example method for enabling a user 101 to provide information for a deliverable and add a buy or sell offer to the system (“the method”) 1000 according to various embodiments described herein. In some embodiments, the method 1000 may start 1001 with a user 101 entering search criteria for a deliverable via the communication engine 131 of their client device 400. In decision block 1002, the communication engine 131 may determine if the product or deliverable (DEL.) is listed in the system database 120. If the deliverable is listed, the method 1000 may continue to decision block 1003 and the execution engine 132 may determine if the deliverable (DEL.) has any buy or sell offers in the system database 120. If the execution engine 132 determines that the deliverable does not have any buy or sell offers in the system database 120 in decision block 1003, the method 1000 may proceed to steps 1013 or 1015 as discussed below. If there are offers, and the user 101 is a buyer 101A, the method 1000 may proceed to step 1004 and the buyer 101A may enter a buy offer to the system 100 via their communication engine 131 in step 1005 and the method 1000 may proceed to method 1100 or the execution engine 132 may enable a oneway buy of the deliverable by matching the buyer 101A to an existing sell offer in step 1006. If there are offers, and the user 101 is a seller 101B, the method 1000 may proceed to step 1007 and the seller 101B may enter a sell offer to the system 100 via their communication engine 131 is step 1009 or the execution engine 132 may enable a oneway sell of the deliverable by matching the seller 101B to an existing buy offer in step 1008.

If the communication engine 131 determines that the product or deliverable is not listed in the system database 120 in decision block 1002, the method 1000 may proceed to step 1010 and the deliverable (DEL.) may be added to the system database 120. Next, in decision block 1011, the inventory engine 134 may determine if the deliverable (DEL.) meets the company's or system metrics for being a deliverable that is handled by the system 100. If the deliverable is not a type that is handled by the system 100, the method 1000 may exit 1012. If the deliverable is a type that is handled by the system 100 and the user 101 is a buyer 101A, the method 1000 may continue to step 1013 and the buyer 101A may enter a buy offer for the deliverable in step 1014 and the method 1000 may proceed to method 1100. If the deliverable is a type that is handled by the system 100 and the user 101 is a seller 101B, the method 1000 may continue to step 1015 and the seller 101B may enter a sell offer for the deliverable in step 1016.

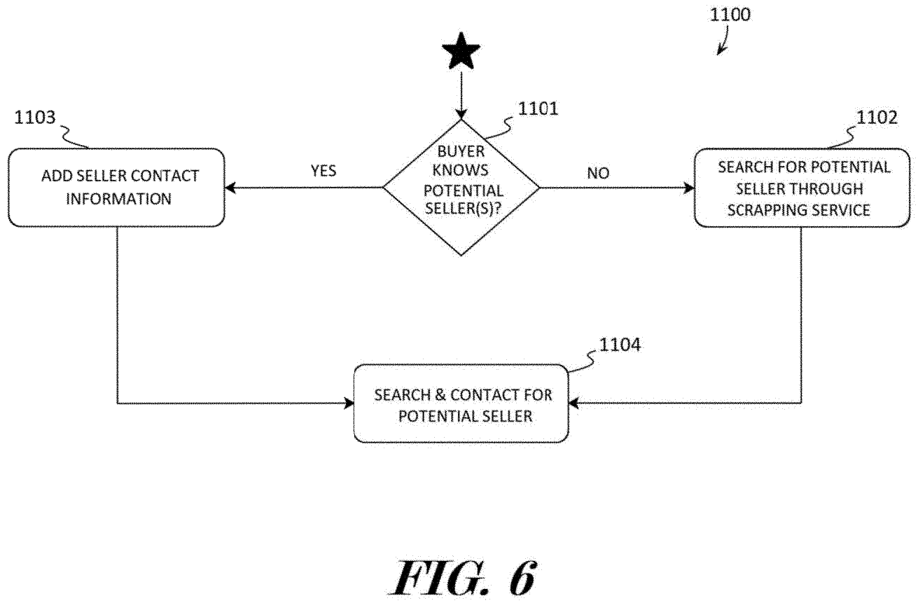

FIG. 6 depicts a block diagram of an example method of getting information describing one or more sellers 101B from a buyer 101A and/or by searching search engines and using scrapping service (“the method”) 1100 according to various embodiments described herein. For example, the method 1100 may be used by the system 100 to enable a buyer 101A to filter the deliverable results of the system 100 to only show offer from sellers 101B that have a certain minimum rating or a certain minimum number of sales or who would ship using a certain company or a certain time frame, and/or to offers from sellers 101B from a certain geographical region or with free shipping or certain return policy, etc. The method 1100 may start, preferably after steps 1005 or 1014 of method 1000, and the communication engine 131 may determine if a buyer 101A knows one or more potential sellers 101B that can sell the deliverable that the buyer 101A desires in decision block 1101. If the communication engine 131 determines the buyer 101A does not know one or more potential sellers 101B, the method 1100 may proceed to step 1102 and the communication engine 131 may search for potential seller 101A through a scrapping service listed below. If the communication engine 131 determines the buyer 101A does know one or more potential sellers 101B, the method 1100 may proceed to step 1103 and the communication engine 131 may ask the buyer 101A to add the contact information of the seller 101A. After steps 1102 and 1103, the communication engine 131 may search and contact for one or more sellers 101B having the deliverable and the deliverable criteria desired by the buyer 101A and the method 1100 may end.

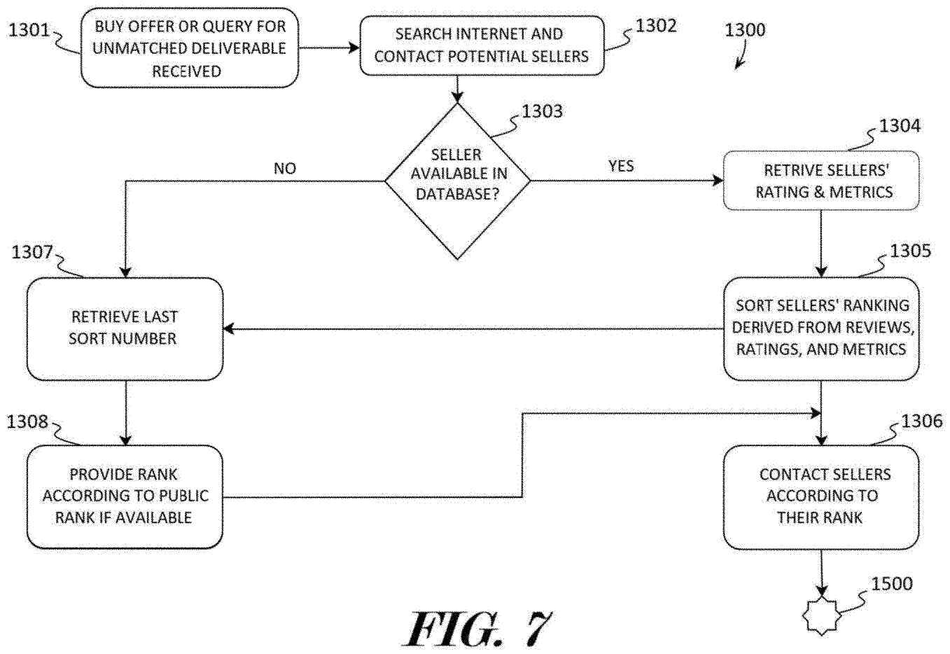

FIG. 7 shows a block diagram of an example method of contacting one or more sellers 101B (“the method”) 1300 according to various embodiments described herein. In some embodiments, the method 1300 may be used by the system 100 to search the internet to find at least one seller for an unmatched deliverable. An unmatched deliverable may comprise a deliverable that does not have a sell offer 142 present in the system 100 for that deliverable and/or an unmatched deliverable may comprise a deliverable that does not exist on the system database 120 (does not have a deliverable data record 141 describing the deliverable). In further embodiments, the method 1300 may be used by the system 100 to contact and solicit one or more sell offers for a deliverable, such as when a buyer 101A may add a buy offer (including checking the validity of credit card/payment method and/or holding money from his account or using money from the wallet) for a deliverable without a sell offer being present for that deliverable, or even if the deliverable does not exist on the system database 120 the buyer 101A can add it. The system 100 may use the method 1300 to search the internet (through other e-commerce websites or search engines or other means to find sellers for that specific item then contact them manually or automatically (via email or phone or other means) to inform them about the buying opportunity so that they can either match the buy offer or submit a counter sell offer.

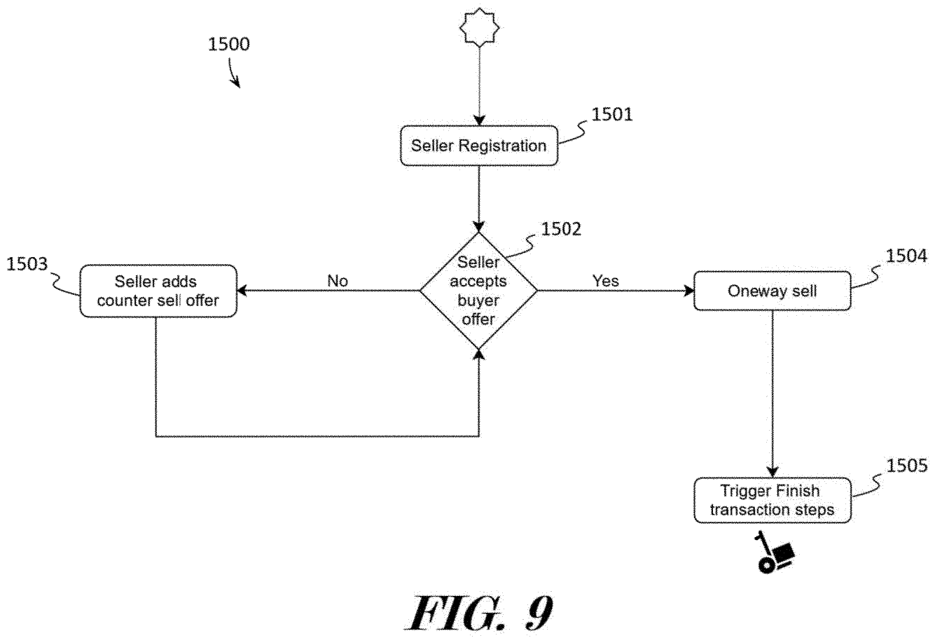

In step 1301, the method 1300 may start and a buy offer 144 or a query by a user 101 may be received by the recommendation engine 135 for an unmatched deliverable. In step 1302, the recommendation engine 135 may search the internet to find at least one seller for the unmatched deliverable and may contact the one or more sellers 101B who can deliver the required unmatched deliverable and preferably having a deliverable that has matching criteria to the unmatched deliverable search criteria provided by a buyer 101A. In decision block 1303, the recommendation engine 135 may determine if the seller 101B is available in the system database 120 by searching for that seller's information in the system database 120. If the seller 101B is available in the system database 120, the method 1300 may proceed to step 1304 and the recommendation engine 135 may retrieve information of the seller 101B, such as the seller's rating and other metrics. Next in step 1305, the recommendation engine 135 may sort the sellers 101B by their ranking that may be derived from reviews, ratings, other metrics, etc. Optionally, after step 1305 the method may proceed to step 1307 or the method 1300 may proceed to step 1306 and the recommendation engine 135 may contact sellers 101B according to their rank or other metric. After step 1306, the method 1300 may proceed to method 1500 (FIG. 9).

If the seller 101B is not available in the system database 120, the method 1300 may proceed to step 1307 and the recommendation engine 135 may retrieve the last sort number/ranking/rating of the seller 101B. The method 1300 may then proceed to step 1308, and the recommendation engine 135 may provide or assign a rank to the seller 101B according to their public rank, such as which may be found on the other e-commerce site that the seller 101B was initially located on or the seller 101B reviews on a search engine if his info was scrapped or retrieved from a search engine. After step, 1308, the method 1300 may proceed to step 1306 and then to method 1500 (FIG. 9).

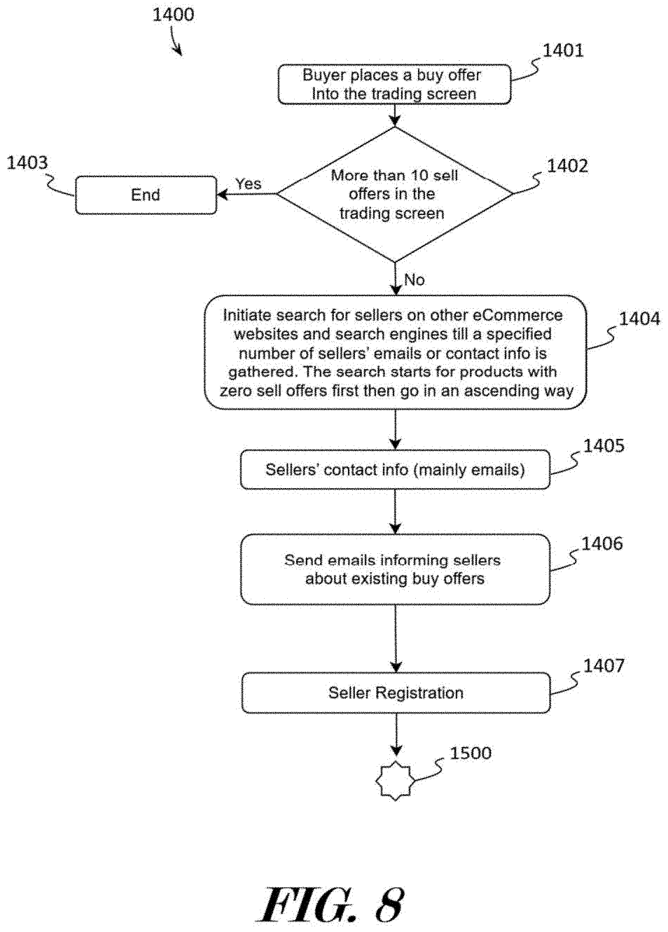

FIG. 8 illustrates a block diagram of an example method of searching for seller(s) 101B over the internet, contacting seller and registering a seller 101B with the system 100 (“the method”) 1400 according to various embodiments described herein. The method 1400 may be used to add sellers 101B that were found by the recommendation engine 135 on one or more third party e-commerce sites and market places or one or more public search engines or recommended by a buyer. In some embodiments, the method 1400 may start by a buyer 101A placing a buy offer for a deliverable into the system 100 via a communication engine 131 on their client device 400. In decision block 1402, the recommendation engine 135 may determine if a desired number of sell offers (in this example, ten offers although any other number may be used) are able to be provided to the buyer 101A such as on a trading screen as may be provided by the communication engine 131. If the desired number of sell offers are able to be provided to the buyer 101A, the method 1400 may proceed to step 1403 and the method 1400 may end.

If the desired number of sell offers are not able to be provided to the buyer 101A, the method 1400 may proceed to step 1404 and the recommendation engine 135 may initiate a search for sellers on one or more other e-commerce websites and/or search engines until a specified or desired number of sellers' emails or other contact information that are able to provide a deliverable that satisfies the buyer's 101A buy offer is gathered. Preferably, the search may start for deliverables with zero sell offers first and then proceed in an ascending way or manner. The matching sellers 101B contact information, such as email addresses, may be stored in the system database 1200 in step 1405. Next, the recommendation engine 135 may contact the sellers 101B, such as via email, to inform the sellers 101B about the one or more existing buy offers in the system 100 in step 1406. Any sellers 101B interested in participating with the system 100 may then be registered with the system 100 preferably via communication engine 131 that may be installed on their client device 400. After step 1407, the method 1400 may proceed to method 1500.

FIG. 9 depicts a block diagram of an example method of completing a deliverable transaction (“the method”) 1500 according to various embodiments described herein. The method 1500 may be used by the system 100 to transfer ownership of a deliverable from seller(s) 101B to buyer(s) 101A. In some embodiments, the method 1500 may start and a seller 101B may be registered with the system 100 so that they may provide sell offers in step 1501 by the communication engine 131. Next in decision block 1502, the execution engine 132 may determine if the seller 101B accepts a buy offer of a buyer 101A, by matching the prices of the buy and sell offers. If the prices of the buy and sell offers do not match, the method 1500 may proceed to step 1503 and the seller 101B may add a counter sell offer or amend their sell offer and the method 1500 may continue the decision block 1502. If the prices of the buy and sell offers do match, the method 1500 may proceed to step 1504 and the execution engine 132 may enable the oneway sale of the deliverable in 1504. Next in step 1505, the transaction may be finalized, such as by determining where the deliverable is to be located after payment has been processed, and the method 1500 may end.

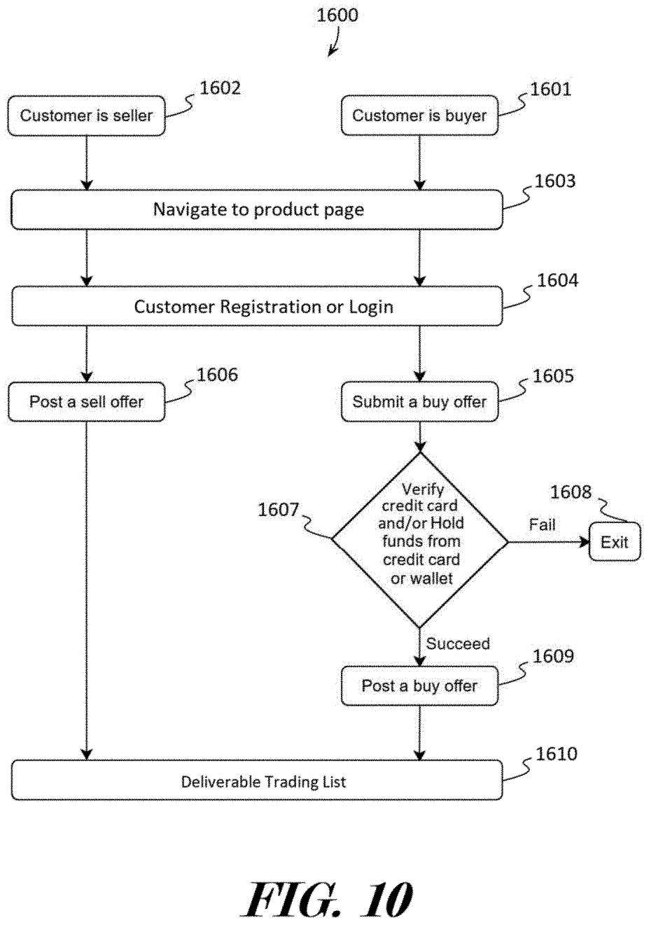

FIG. 10 shows a block diagram of an example method of posting offers in the system (“the method”) 1600 according to various embodiments described herein. The method 1600 may be used to allow buyers 101A and sellers 101B to post or provide buy and sell offers into the system 100 so that the offers may be provided to one or more other buyers 101A and sellers 101B.

In some embodiments, the method 1600 may start and a buyer 101A, in step 1601, may navigate to the product page (page providing information on deliverables of the system 100) via the communication engine 131 running on their client device 400 in step 1603. Likewise, a seller 101B, in step 1602, may navigate to the product page (page providing information on deliverables of the system 100) via the communication engine 131 running on their client device 400 in step 1603. The buyer 101A and seller 101B may then complete a customer registration, such as by registering as a new user 101 or logging in as an existing user 101, in step 1604 via the communication engine 131. By providing or submitting a buy offer in step 1605 via the communication engine 131, the user 101 may act as a buyer 101A and the method 1600 may proceed to decision block 1607 and the transaction engine 133 may determine if it is able to verify credit card (payment method) and/or hold funds sufficient for covering the amount specified in the buy offer, such as from a credit card or wallet stored by the system 100. If the transaction engine 133 determines it is not able to verify credit card (payment method) and/or hold sufficient funds, the submitting of the buy offer may fail and the method 1600 may exit 1608. If the transaction engine 133 determines it is able to verify credit card (payment method) and/or hold sufficient funds, the submitting of the buy offer may succeed and the method 1600 may continue to step 1609 in which the buy offer may be entered into the system database 120. Next, the buy offer may be displayed to one or more other users 101 via the communication engines 131 on their respective client device 400 in step 1610, such as on a product or deliverable trading list screen and the method 1600 may end.

By providing or submitting a sell offer in step 1606 via the communication engine 131, the user 101 may act as a seller 101B and the method 1600 may proceed to 1610. Next, the sell offer may be displayed to one or more other user 101 via the communication engines 131 on their respective client device 400 in step 1610, such as on a product or deliverable trading list screen and the method 1600 may end.

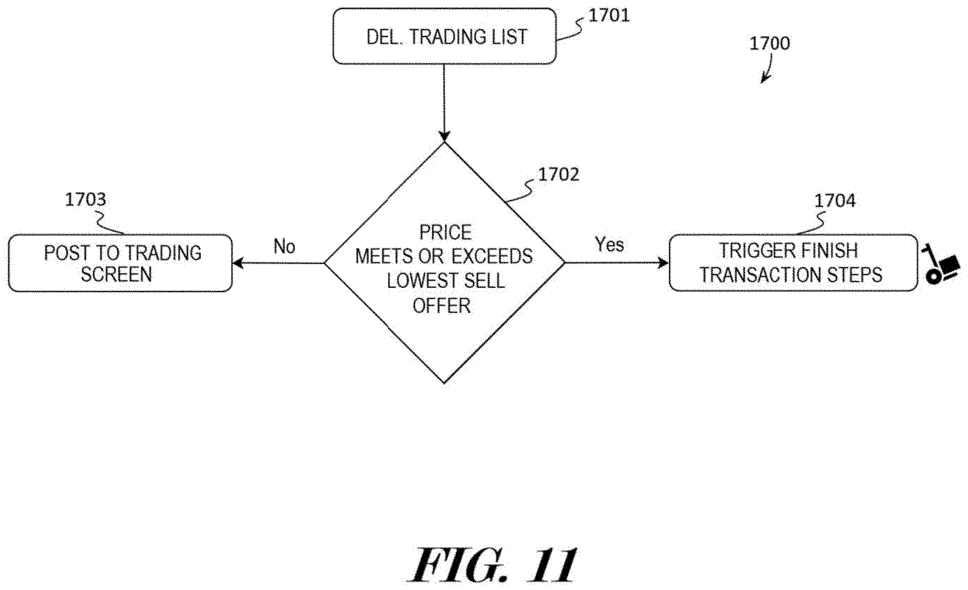

FIG. 11 illustrates a block diagram of an example method of completing a transaction for a buy offer of a single deliverable (“the method”) 1700 according to various embodiments described herein. The method 1700 may be used by the system 100 to complete a transaction for a buy offer on a single deliverable or item purchase. In some embodiments, the method 1700 may start and a buyer 101A may be presented with a deliverable (DEL.) or product trading list of the system 100 and the buyer 101A may input a buy offer into the system 100 for a single unit of a deliverable via the communication engine 131 of their client device 400 in step 1701. In decision block 1702, the execution engine 132 may determine if the price of the buy offer meets or exceed the lowest sell offer for the deliverable. If the price of the buy offer does not meet or exceed the lowest sell offer for the deliverable, the buy offer may then be posted to the product trading list of the system 100 having one or more buy offers and sell offers for the deliverable in step 1703 and the method 1700 may end. If the price of the buy offer does meet or exceed the lowest sell offer for the deliverable, the execution engine 132 may match the buy and sell offers and trigger one or more steps to finish the transaction in step 1704 and the method 1700 may end.

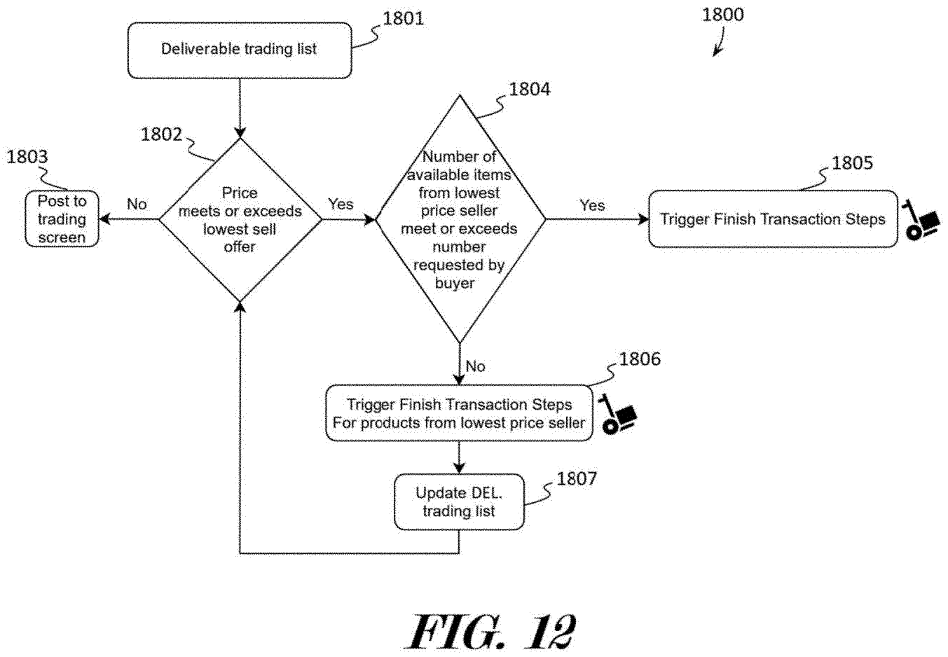

FIG. 12 depicts a block diagram of an example method of completing a transaction of a buy offer for a quantity of a deliverable (“the method”) 1800 according to various embodiments described herein. The method 1800 may be used by the system 100 to complete a transaction for a buy offer for a specific quantity of a deliverable. In some embodiments, the method 1800 may start and a buyer 101A may be presented with a deliverable or product trading list of the system 100 and the buyer 101A may input a buy offer into the system 100 for a quantity of a deliverable via the communication engine 131 of their client device 400 in step 1801. In decision block 1802, the execution engine 132 may determine if the price of the buy offer meets or exceed the lowest sell offer for the deliverable. If the price of the buy offer does not meet or exceed the lowest sell offer for the deliverable, the buy offer may then be posted to the product trading list of the system 100 having one or more buy offers and sell offers for the deliverable in step 1803 and the method 1800 may end. If the price of the buy offer does meet or exceed the lowest sell offer for the deliverable, the method 1800 may proceed to decision block 1804, and the execution engine 132 may determine if the number of available items or deliverables from the lowest price seller meets or exceeds the number or quantity of deliverable requested by the buyer 101A in their buy offer. If the number of available items or deliverables from the lowest price seller meets or exceeds the number or quantity of deliverable requested, the execution engine 132 may match the buy and sell offers and trigger one or more steps to finish the transaction in step 1805 and consequently reduce the quantity of items/deliverables available from the sell offer by the of number of items sold/executed. After step 1805, the method 1800 may end. If the number of available items from the lowest price seller does not meet or exceed the number or quantity of deliverable requested, the execution engine 132 may match the buy and sell offers for the less than desired quantity of deliverables and trigger one or more steps to finish the transaction in step 1806. Next in step 1807, the execution engine 132 may deduct that quantity of deliverables from the buy offer and then update the product or deliverable (DEL.) trading list with the updated buy offer and the method 1800 may proceed to decision block 1802.

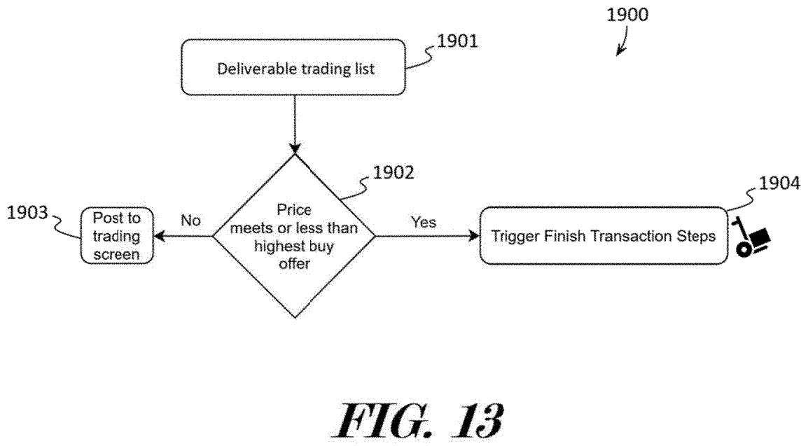

FIG. 13 shows a block diagram of an example method of completing a transaction for a sell offer of a single unit of a deliverable (“the method”) 1900 according to various embodiments described herein. The method 1900 may be used by the system 100 to complete a transaction for a sell offer on a single deliverable or item purchase. In some embodiments, the method 1900 may start and a seller 101B may be presented with a deliverable or product trading list of the system 100 and the seller 101B may input a sell offer into the system 100 for a single deliverable via the communication engine 131 of their client device 400 in step 1901. In decision block 1902, the execution engine 132 may determine if the price of the sell offer meets or is less than the highest buy offer for the deliverable. If the price of the sell offer does not meet or is not less than the highest buy offer for the deliverable, the sell offer may then be posted to the product trading list of the system 100 having one or more buy offers and sell offers for the deliverable in step 1903 and the method 1900 may end. If the price of the sell offer does meet or is less than the highest buy offer for the deliverable, the execution engine 132 may match the buy and sell offers and trigger one or more steps to finish the transaction in step 1904 and the method 1900 may end.

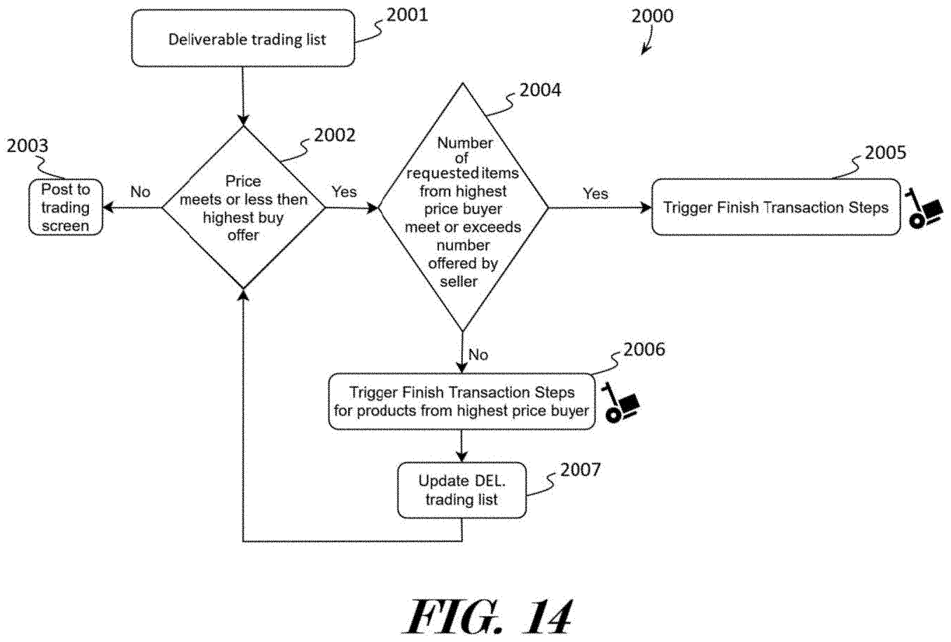

FIG. 14 illustrates a block diagram of an example method of completing a transaction of a sell offer for a quantity of a deliverable (“the method”) 2000 according to various embodiments described herein. The method 2000 may be used by the system 100 to complete a transaction for a sell offer for a specific quantity of a deliverable. In some embodiments, the method 2000 may start and a seller 101B may be presented with a deliverable or product trading list of the system 100 and the seller 101B may input a sell offer into the system 100 for a quantity of a deliverable via the communication engine 131 of their client device 400 in step 2001. In decision block 2002, the execution engine 132 may determine if the price of the sell offer meets or is less than the highest buy offer for the deliverable. If the price of the sell offer does not meet or is not less than the highest buy offer for the deliverable, the sell offer may then be posted to the product trading list of the system 100 having one or more buy offers and sell offers for the deliverable in step 2003 and the method 2000 may end. If the price of the sell offer does meet or is less than the highest buy offer for the deliverable, the method 2000 may proceed to decision block 2004, and the execution engine 132 may determine if the number of requested items or deliverables from the highest price buyer 101A meets or exceeds the number or quantity of deliverable offered by the seller 101B in their sell offer. If the number of requested items from the highest price buyer 101A meets or exceeds the number or quantity of deliverable available, the execution engine 132 may match the buy and sell offers and trigger one or more steps to finish the transaction in step 2005 and the method 2000 may end. If the number of requested items from the highest price buyer 101A does not meet or exceed the number or quantity of deliverable available, the execution engine 132 may match the buy and sell offers for the less than offered quantity of deliverables and trigger one or more steps to finish the transaction in step 2006. Next in step 2007, the execution engine 132 may deduct that quantity of deliverables from the sell offer and then update the product or deliverable (DEL.) trading list with the updated sell offer and the method 2000 may proceed to decision block 2002.

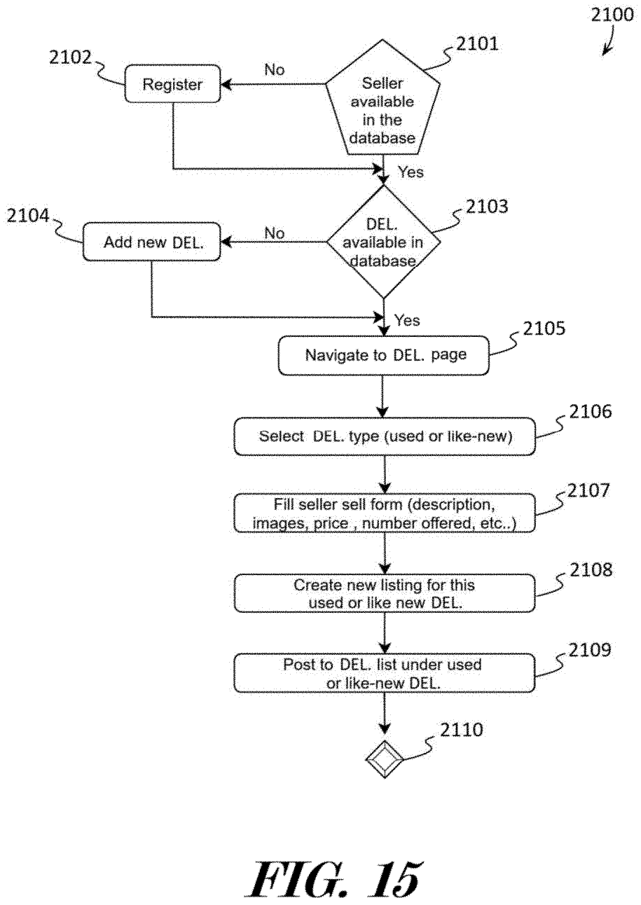

FIG. 15 depicts a block diagram of an example method of adding a deliverable and/or sell offer to the system 100 (“the method”) 2100 according to various embodiments described herein. The method 2100 may be used by the system 100 to add a deliverable to the system database 120 so that one or more buy offers and/or sell offers for the deliverable may be used to complete a transaction for the deliverable. Preferably, the method 2100 may be used mainly for used or like-new deliverables but can be also extended to new, refurbished, etc., deliverables.

In some embodiments, the method 2100 may start and a user 101 having a deliverable that they desire to have added to the system database 120 may use the communication engine 131 of their client device 400 to determine if they are a seller 101B of the system 100 and therefore stored in the system database 120. If the user 101 is not in the system 100, the method 2100 may proceed to step 2102 and the user 101 may register or enroll in the system 100 as a seller 101B. If the user 101 is in the system 100, the method 2100 may proceed to decision block 2103 and the inventory engine 134 may determine if the deliverable (DEL.) or product is available in the system database 120 via search criteria of the deliverable. If the deliverable or product is not available in the system database 120, the method 2100 may proceed to step 2104 and the deliverable (DEL.) may be added to the system database 120. If the deliverable or product is available in the system database 120, the communication engine 131 may navigate the seller 101B to the product page for the deliverable (DEL.) in step 2105. In steps 2106 and 2107 the seller 101B may enter information describing the deliverable via the communication engine 131 of their client device 400. For example, in step 2106 the seller 101B may enter information describing if the deliverable (DEL.) is of a new condition, like-new condition, used condition, refurbished condition, etc., and in step 2107 the seller 101B may enter information to complete a seller form, such as description, images, price, numbered offered, and any other information describing the deliverable and/or the sell offer. In step 2108, the inventory engine 134 may create a new listing for the deliverable (DEL.). In step 2109, the inventory engine 134 may post the deliverable (DEL.) to make the deliverable available in the system 100 so that one or more buy offers and/or sell offers may be posted for the deliverable. After step 2109, the method 2100 may finish 2110.

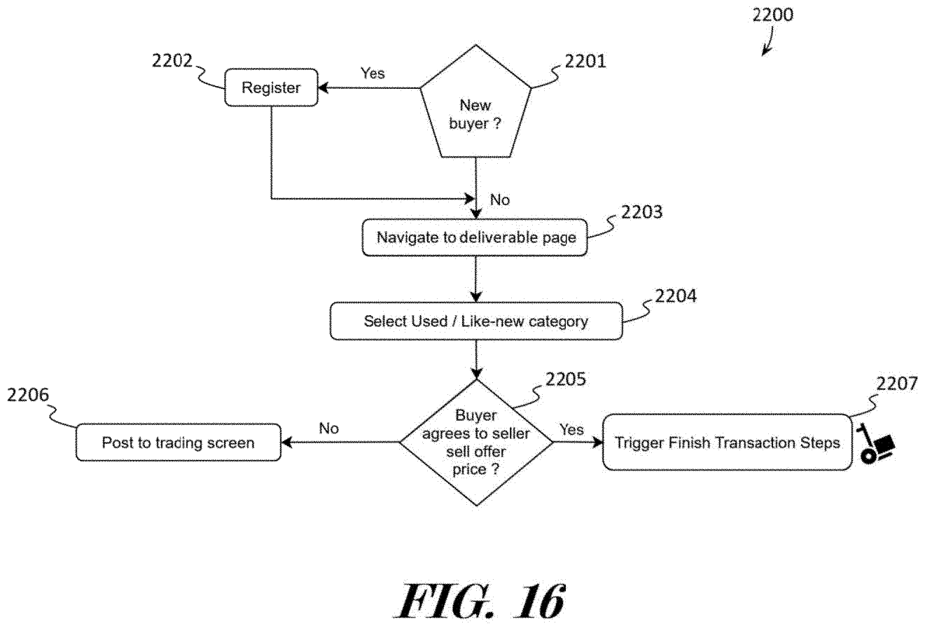

FIG. 16 shows a block diagram of an example method of completing a one way buy for a deliverable (“the method”) 2200 according to various embodiments described herein. The method 2200 may be used by the system 100 to allow a buyer to complete a one way buy for a deliverable without having to post a buy offer for a deliverable, such as when a buyer 101A finds a seller's 101B price acceptable and wishes to immediately complete a transaction for the deliverable. Preferably, the method 2200 may be used mainly for used or like-new deliverables but can be also extended to new, refurbished, etc., deliverables.

In some embodiments, the method 2200 may start and a user 101 having a deliverable that they desire to acquire ownership of may use the communication engine 131 of their client device 400 to determine if they are a buyer 101A of the system 100 and therefore stored in the system database 120. If the user 101 is not in the system 100, the method 2200 may proceed to step 2202 and the user 101 may register or enroll in the system 100 as a buyer 101A. If the user 101 is in the system 100 and therefore not a new buyer, the method 2200 may proceed to step 2203 and the communication engine 131 may navigate the buyer 101A to the product page to search for the deliverable. In step 2204 the buyer 101A may enter information describing the deliverable via the communication engine 131 of their client device 400. For example, in step 2204 the buyer 101A may enter information describing if the deliverable is of a new condition, like-new condition, used condition, refurbished condition, etc. and the inventory engine 134 may return deliverables that match the information entered in step 2204. Next in decision block 2205, the execution engine 132 may determine if the buyer 101A agrees to the sell offer of a seller 101B of the deliverable via input provided by the buyer 101A via the communication engine 131 of their client device 400. If the buyer 101A does not agree to the sell offer of a seller 101B of the deliverable, the method 2200 may proceed to step 2206 and the inventory engine 134 may generate a buy offer for the buyer 101A for the deliverable and the method 2200 may end. If the buyer 101A does agree to the sell offer of a seller 101B of the deliverable, the method 2200 may proceed to step 2207 and the execution engine 132 may trigger one or more steps to finish the transaction and the method 2200 may end.

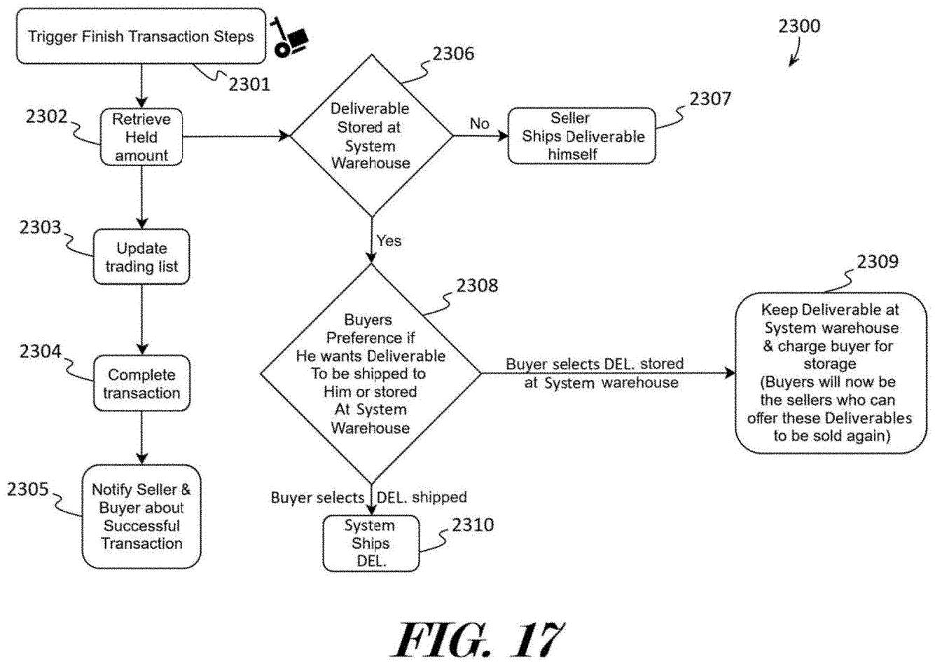

FIG. 17 illustrates a block diagram of an example method of determining a deliverable location post transaction (“the method”) 2300 according to various embodiments described herein. The method 2300 may be used by the system 100 to determine where a deliverable is to be located once ownership of the deliverable has been transferred from a seller 101B to a buyer 101A. The system 100 may enable deliverables, such as items or merchandise, to be kept at a seller location or warehouse, sent to a buyer location or warehouse, or kept at a system warehouse 106.

For example, when a transaction is completed, the buyer 101A may request to have the deliverable(s) shipped to him or keep them stored at a seller warehouse or keep them stored at a system warehouse 106, in both cases the buyer 101A will have to pay fees for storage. The buyer 101A can then offer the items to be sold on the system 100 website again for other users 101 to buy. This may mainly be used if the deliverables are bought in large quantities so that intermediate sellers 101B can buy in large quantities, keep the products at a system warehouse 106, and then offer them for sale in smaller quantities and at higher price, preferably depending on buyer request or input that may be submitted during the placing or creation of the buy offer and/or later on before the warehouse 106 ships the deliverable. Using this buyer request or input an inventory engine 134 may be configured to determine if a deliverable is to be stored in a system warehouse 106 or to be shipped to the buyer 101A or other user 101, individual, company, entity, etc., after the creation of a deliverable transaction.

As another example, a wholesaler or manufacturer (first seller 101A) owns thousands of a certain deliverable X. He sends 5000 pieces to be stocked in a system warehouse 106 and then sold via the system 100. He places his sell offer for a price of $7 per piece with a MOQ (Minimum Ordering Quantity) of 1000. The only buyers 101A who can see this offer will be the distributors or middle agents who look to buy at least 1000 piece and typically then sell them in smaller quantities with higher price to make profit. So, a first buyer 101A searched for deliverable X in quantities of 1000 or more and he agreed to pay $7 per piece with ordering a MOQ of 1000. The ownership of the 1000 pieces of deliverable now is transferred from the first seller 101A to the first buyer 101A. First buyer 101A now has 2 options, either to have the system 100 ship the 1000 piece to a desired location for the shipping fee agreed upon, or to keep his 1000 pieces of deliverable stocked at the system warehouse 106 and then put selling offers for the deliverable in desired quantities into the system 100. Now, first buyer 101A will be considered second seller 101B. He may place an offer for selling deliverable X for $10 per piece with a MOQ of 100, so when he sells his 1000 items to just ten buyers 101A he would make $3000 profit. Second buyer 101A now searches for deliverable with MOQ of 100 and buys them from second seller 101B and so on until seller X just buys 10 items and starts to sell them one by one. So, the system 100 will be profiting from the stocking fee of the deliverables starting when they are a big lot of 5000 pieces and until they are sold one by one. In addition, the system 100 will be profiting for the multiple commissions gained every time the item is sold. Even a buyer 101A who buys just one item (which may be on sale or clearance) can keep it stocked at a system warehouse 106 for him to sell it later on through the system 100 and still make some profit too.

In some embodiments, the method 2300 may start when the transaction finishing steps (1505, 1704, 1805, 1806, 1904, 2005, 2006, 2207, from an above method are triggered in step 2301. Next in step 2302, the inventory engine 134 may retrieve the held amount of funds from credit card or wallet in exchange of the deliverables from the transaction. After step 2302, the method 2300 may proceed to steps 2303 and 2306. In step 2303, the inventory engine 134 may update the trading list for the deliverable in the system database 120. In step 2304, the transaction engine 133 may complete the transaction, such as by transferring funds and ownership between the buyer 101A and seller 101B, and in step 2305, the communication engine 131 may notify the seller 101B and buyer 101A about the successful completion of the transaction.

In decision block 2306, the inventory engine 134 may determine if the deliverable or product is stored at a system warehouse 106 by searching the system database 120 for the current deliverable location(s). If the deliverable or product is not stored at a system warehouse 106, then the deliverable to be shipped by the seller 101B and the seller 101B is notified via the communication engine 131 of their client device 400. If the deliverable or product is stored at a system warehouse 106, then the method 2300 proceeds to decision block 2308 and the inventory engine 134 determines the buyer's 101A preference of if the buyer 101A wants the deliverable shipped to him or to remain stored in the system warehouse 106 using buyer 101A input received via the communication engine 131 of their client device 400. In some embodiments, depending on buyer 101A request or input that may be submitted during the placing or creation of the buy offer and/or later on before the warehouse 106 ships the deliverable.

If the buyer 101A wants the deliverable to remain stored in the system warehouse 106, the method 2300 may proceed to step 2309 and the inventory engine 134 may keep the deliverable at the system warehouse 106 and charge the buyer 101A for storage of the deliverable (the buyer 101A may now act as a seller 101B that can offer the deliverable(s) to be sold again via the system 100) and the method 2300 may end.

If the buyer 101A wants the deliverable shipped to him, the method 2300 may proceed to step 2310 and the inventory engine 134 may ship the deliverable to the buyer 101A and the method 2300 may end.

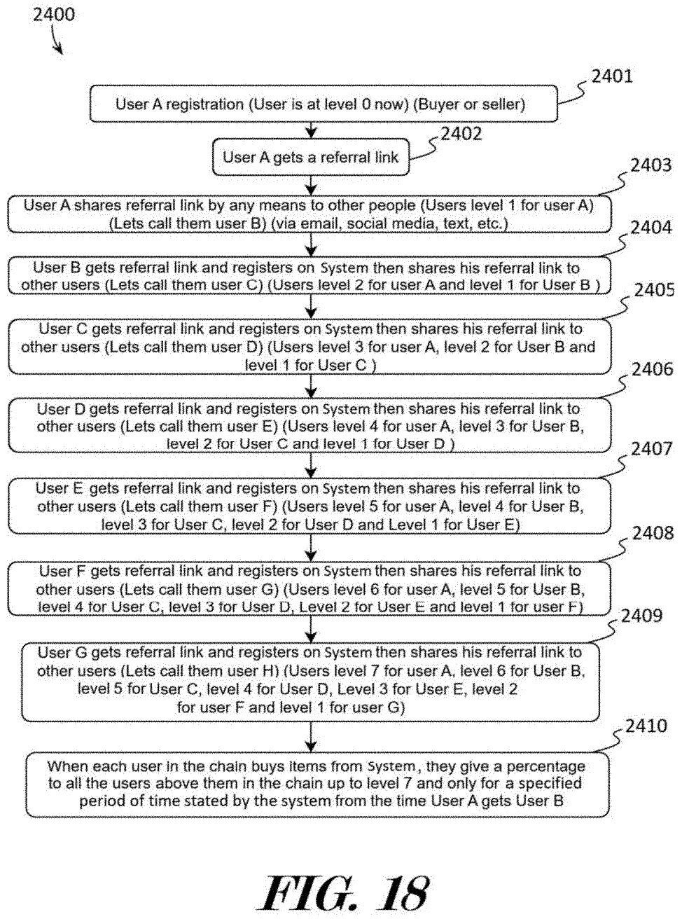

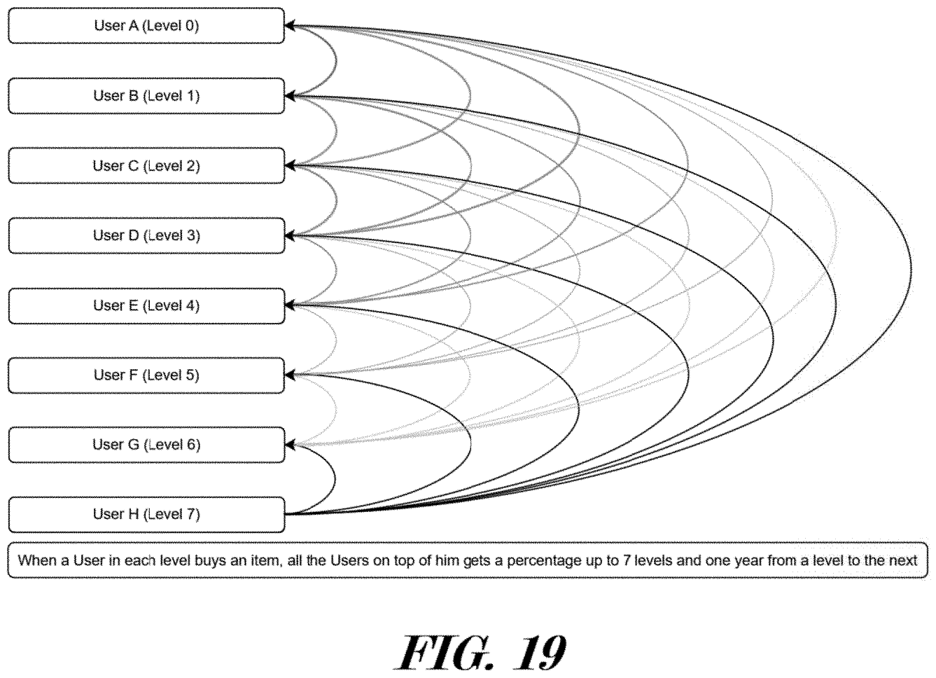

FIG. 18 depicts a block diagram of an example method of processing a transaction based on the number of users associated with one or more users of the system (“the method”) 2400 and FIG. 19 shows a graphical representation of users associated with other users in the system database according to various embodiments described herein. The method 2400 may be used to distribute commissions from transaction between users 101 that are associated with each other in the system database 120.

In some embodiments, the method 2400 may start and an individual may register with the system 100 as a user in step 2401. In step 2402, the registered user 101 may receive a referral link from the communication engine 131. Any registered user 100 (in this example User A) who is registered with the system 100 can have an affiliate link that connects to his account. In step 2403, User A may then share the affiliate link with any means (email or any way he likes) with other individuals that can use the link to register with the system as users 101. In this example, an individual uses the link to register as a user 101 in the system 100 that may be designated as User B. In step 2404, User B may then share the affiliate link with any means (email or any way he likes) with other individuals that can use the link to register with the system as users 101. In this example, an individual uses the link to register as a user 101 in the system 100 that may be designated as User C. In step 2405, User C may then share the affiliate link with any means (email or any way he likes) with other individuals that can use the link to register with the system as users 101. In this example, an individual uses the link to register as a user 101 in the system 100 that may be designated as User D. In step 2406, User D may then share the affiliate link with any means (email or any way he likes) with other individuals that can use the link to register with the system as users 101. In this example, an individual uses the link to register as a user 101 in the system 100 that may be designated as User E. In step 2407, User E may then share the affiliate link with any means (email or any way he likes) with other individuals that can use the link to register with the system as users 101. In this example, an individual uses the link to register as a user 101 in the system 100 that may be designated as User F. In step 2408, User F may then share the affiliate link with any means (email or any way he likes) with other individuals that can use the link to register with the system as users 101. In this example, an individual uses the link to register as a user 101 in the system 100 that may be designated as User G. In step 2409, User G may then share the affiliate link with any means (email or any way he likes) with other individuals that can use the link to register with the system as users 101. In this example, an individual uses the link to register as a user 101 in the system 100 that may be designated as User H. In this manner users 101 may be associated with one or more other users 101. Next, in step 2410 the transaction engine 133 may distribute commissions from transaction between users 101 that are associated with each other in the system database 120. Continuing the above example, when each user 101 in the chain buys deliverables from the system 100, a percentage of the transaction is distributed to all the users above them in the chain up to a specified level, such as level 7, and preferably only for a limited time period, such as one year from the date of step 2403. After step 2410, the method 2400 may end.

Still referring to FIGS. 18 and 19, another example is presented. When a new user 101 (let's call him user 1) clicks on a referral link and registers he is put in the system 100 under user zero, meaning that any buy offers that complete as transactions, the previous user (user zero) will get a percentage of it (such as 0.25%) (this may be an addon setting). If user 1 accesses the system 100 anytime in the future not from the affiliate link that he first got, meaning he just types in the system 100 web address, he should may still be enrolled under user zero and all his buy offers may still give a percentage (such as 0.25%) to user zero. User zero can send his affiliate link to any number of people and they can all register and be under him so one user 101 can have even a thousand other users 101 associated with him and under him in level 1. User 1 will have his affiliate link and may send it to any number of people, any person who registers as a user 101 after clicking on user's 1 link (user 2) will be in level 2 relative to user zero and in level 1 relative to user 1. For any buy offers that complete as transactions by user 2, user 1 will get a percentage (such as 0.25%) and user zero will get also a percentage (such as 0.25%), additionally, these example percentages can change. This continues until there are a set number of levels, such as 7 levels, of users 101 under user Zero, and after that he may not get a percentage of the sales. Preferably, the maximum a user 101 can get is a percentage from the set number of levels, such as 7 levels, of users 101 under him, and after that nothing so if a user 101 in level 7 buys something, all the users 101 in the 7 levels above him (0, 1, 2, 3, 4, 5, 6) each will get, for example, 0.25% so the system 100 may be paying a maximum of, for example, 0.25×7=1.75% of the purchase price of a deliverable as commission. This may be valid for users 101 at any level, meaning one user 101 in level 3 relative to user zero can get another 7 levels under him but only three of them will be paying to user zero while the rest will just be paying to him.

This commission structure may be only valid for a time period such as one year from the day a user 101 gets a user under him. For example, if on January first the user zero gets another user under him (user 1), then until January first of the following year, he can get the 0.25% percent from up to 7 levels under him. The only way he can continue to get a percentage is to refer new users 101 so if on February first he got another user 101 under him so he will continue to get the 0.25% from up to 7 levels under the new user 101 till February first of next year. This may serve as an incentive to make users 101 continue to refer new people under them all the time. In further embodiments, when a user 101 gets money from the users 101 under him, he may not get the money right away, but only after a desired time period, such as one month from delivery, such as after the time period in which returns on the deliverable are no longer accepted. Once the money is available, the user 101 may optionally convert it into a gift certificate to be used to buy merchandise only from the system 100.

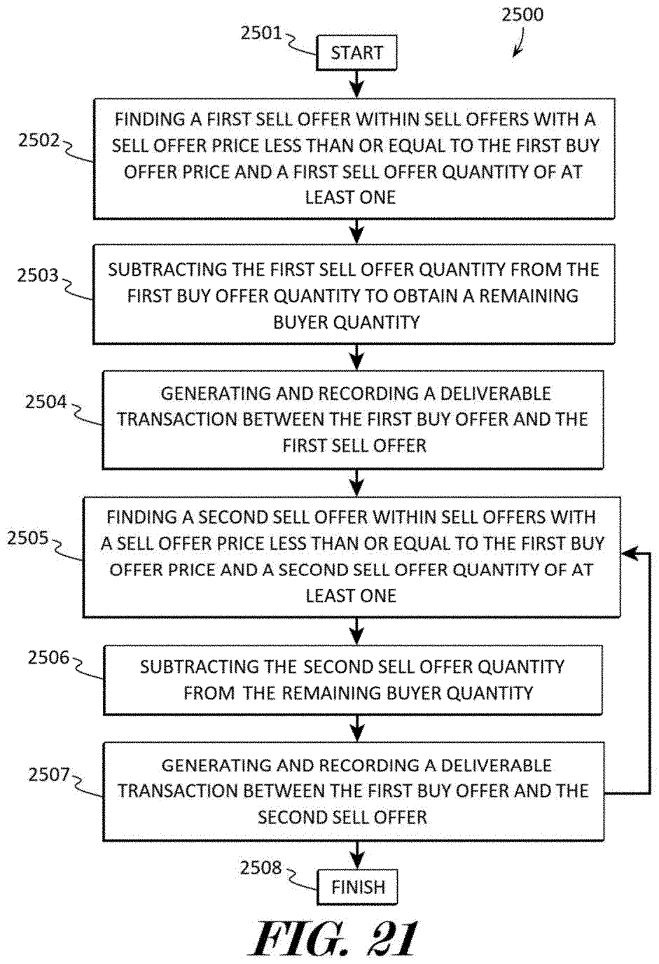

FIG. 21 depicts a block diagram of an example of a computer implemented process for matching a buy offer requesting more than one quantity of a deliverable with one or more sell offers (“the method”) 2500 that may be used by the system 100 according to various embodiments. The system 100 may include a system database 120, stored in a data store 308, 408, having a deliverable data record 141 that includes information describing a first deliverable. A plurality of sell offers 142, 146, may be associated with the first deliverable 141 stored in the system database 120, and the plurality of sell offers 142, 146, may have a plurality of sell offer prices 143A, 147A, and a plurality of sell offer quantities 143B, 147B, for the first deliverable 141. For example, the system 100 may have many sell offers 142, 146, for a specific deliverable 141 (product), in this example five sellers 101B, and the sellers 101B may have sell offers 142, 146, having different sell offer quantities 143B, 147B, and different sell offer prices 143A, 147A, such as: seller K has 2 pieces available with price $10 each; seller L has 3 pieces available with price $11 each; seller M has 1 piece available with price $12 each; seller N has 4 pieces available with price $13 each; and seller O has 2 pieces available with price $14 each. In some embodiments, a deliverable 141 of the method 2500 may be: physically or digitally transferred to a first buyer 101A and no longer stored within the system 100; or the deliverable 141 may be stored within the system database 120 or physically stored within a system warehouse 106, and a buyer data record 151 and a seller data record 153 may be updated to reflect the transfer of ownership of the deliverable 141 without having to move the deliverable 141 to the buyer 101A.

A first buy offer (optionally a buy offer 144 or a hidden buy offer 148) may be associated with the first deliverable 141 in the system database 120, and the first buy offer 144, 148, may specify a first buy offer price 145A, 149A, and a first buy offer quantity 145B, 149B, for the first deliverable 141. Continuing the above example, a buyer 101A may input a buy offer 144, 148, in which and he wants to buy, for example, 10 pieces (buy offer quantity 145B, 149B) with a bid price of, for example, $12.50 (buy offer price 145A, 149A,). In some embodiments, one or more of the following conditions may be true: the first buy offer price may be for a hidden buy offer 148 and the hidden buy offer price 149A may be hidden and not be displayed by the communication engine 131; the first sell offer price may be for a hidden sell offer 146 and the hidden sell offer price 147A may not be displayed by the communication engine 131; the buyer identifier 152 used for identifying a first buyer 101A may be hidden and not displayed by the communication engine 131; and a seller identifier 154 used for identifying a first seller 101B may be hidden and not displayed and not displayed by the communication engine 131.

The method 2500 may start 2501 and may be performed by an execution engine 132 that may be configured to determine one or more sellers 101B. In step 2502, the execution engine 132 may find a first sell offer 142, 146, within the plurality of sell offers 142, 146, in the system database 120 with (i) a sell offer price 143A, 147A, less than or equal to the first buy offer price 145A, 149A, and (ii) a first sell offer quantity 143B, 147B of at least one. Continuing the above example, the $12.5 buy offer price 145A, 149A, is more than or equal to the lowest sell offer price 143A, 147A of $10 from seller K. Preferably, as the $12.5 is equal to or more than the lowest sell offer price 143A, 149A, the execution engine 132 may match the offer of the buyer 101A with the lowest sell offer price 143A, 147A, of seller K (for $10) so to preferably favor the buyer 101A and give the lowest price of bid and offer price, so they will match for $10 not $12.5.

In step 2503, the execution engine 132 may subtract the first sell offer quantity 143B, 147B, from the first buy offer quantity 145B, 149B, to obtain a remaining buyer quantity. A remaining buyer quantity may comprise the number or quantity of deliverable that is still required in order to meet or satisfy the buy offer quantity 145B, 149B, of the buy offer 144, 148.

In step 2504, the execution engine 132 may generate and record a deliverable transaction between the first buy offer 144, 148, and the first sell offer 142, 146, when the conditions (i) and (ii) of step 2502 are met. Continuing the above example, the execution engine 132 will match this buy offer 144, 148, with the lowest sell offer price 143A, 147A, of seller K ($10) and match 2 pieces to generate and record a deliverable transaction for the 2 pieces. Then, as the buyer 101A wants to buy 10 pieces, the execution engine 132 may modify the buy offer quantity 145B, 149B, of this buy offer 144, 148, from 10 pieces to 8 pieces (after 2 pieces went to Seller K) with the same bid price of $12.5. In this example, the remaining buyer quantity is 8 and since the remaining buyer quantity is 8, the method 2500 may continue and perform steps 2505 to 2507 repeatedly (as needed) until the remaining buyer quantity is zero thereby signifying that the buy offer quantity 145B, 149B, of the buy offer 144, 148, has been meet or satisfied or until there is no more sell offer price 143A, 147A in any sell offer 142, 146 that is less than or equal to the buy offer price 145A, 149A, for example seller N and O mentioned above.

In step 2505, the execution engine 132 may find a second sell offer 142, 146, within the plurality of sell offers 142, 146, with a sell offer price 143A, 147A, less than or equal to the first buy offer price 145A, 149A ($12.5), and a second sell offer quantity 143B, 147B, of at least one. Continuing the above example, the execution engine 132 may match the buy offer 144, 148, of the buyer 101A with the sell offer 142, 146, of seller L having 3 pieces (for $10) so to preferably favor the buyer 101A and give the lowest price of bid and offer price, so they will match for $10 not $11.

In step 2506, the execution engine 132 may subtract the second sell offer quantity 143B, 147B from the remaining buyer quantity. Continuing the above example, the execution engine 132 may subtract the 3 pieces from the remaining buyer quantity of 8.

In step 2507, the execution engine 132 may generate and record a deliverable transaction between the first buy offer 144, 148, and the second sell offer 142, 146. In preferred embodiments, steps 2505-2507 may be repeated until one of the following conditions is reached (i) the remaining buy offer quantity is zero and all of the buy offer quantities are filled, and (ii) a sell offer price that is less than or equal to the first buy offer price is not found. Continuing the above example, the execution engine 132 will generate and record a deliverable transaction between the buy offer 144, 148, and the sell offer 142, 146, of seller L. The execution engine 132 may repeat steps 2506 and 2507 as the remaining buyer quantity is now 5 pieces with the same bid price of $12.5. The execution engine 132 may repeat step 2505 to again automatically match the buy offer 144, 148, with another 1 piece from seller M (for $10) so to preferably favor the buyer 101A and give the lowest price of bid and offer price, so they will match for $10 not $11, repeat the subtraction of step 2506, and repeat the complete a transaction in step 2507. As the buyer 101A originally wants to buy 10 pieces so his buy offer is now reduced from 5 pieces (after 2 went to seller K, 3 went to seller L and 1 went to seller M) to 4 pieces with the same bid price of $12.5. Now the method 2500 may stop as the next offer from Seller N has a sell offer price 143A, 147A, of $13 which is more than the buy offer price 145A, 149A, so the execution engine 132 will stop at this stage and leave a buy offer 144, 148, in the system 100 for the buyer 101A for 4 pieces (buy offer quantity 145B, 149B,) at $12.5 (buy offer price 145A, 149A) and the method 2500 may finish 2508.

In some embodiments the system 100, the buy offer price 145A, 149A, of a buy offer 144, 148, may be lowered by the execution engine 132 to the sell offer price 143A, 147A, of a sell offer 142, 146, when the sell offer price 143A, 147A, is less than the buy offer price 145A, 149A. For example, a buy offer 144, 148, for a deliverable 141 may have a buy offer price 145A, 149A, of $50.00 and if there is a sell offer 142, 146, for the deliverable 141 having a sell offer price 143A, 147A, of $45.00, the execution engine 132 may lower the buy offer price 145A, 149A, to $45.00, and may preferably complete a deliverable transaction between the buy offer 144, 148, and the sell offer 142, 146.

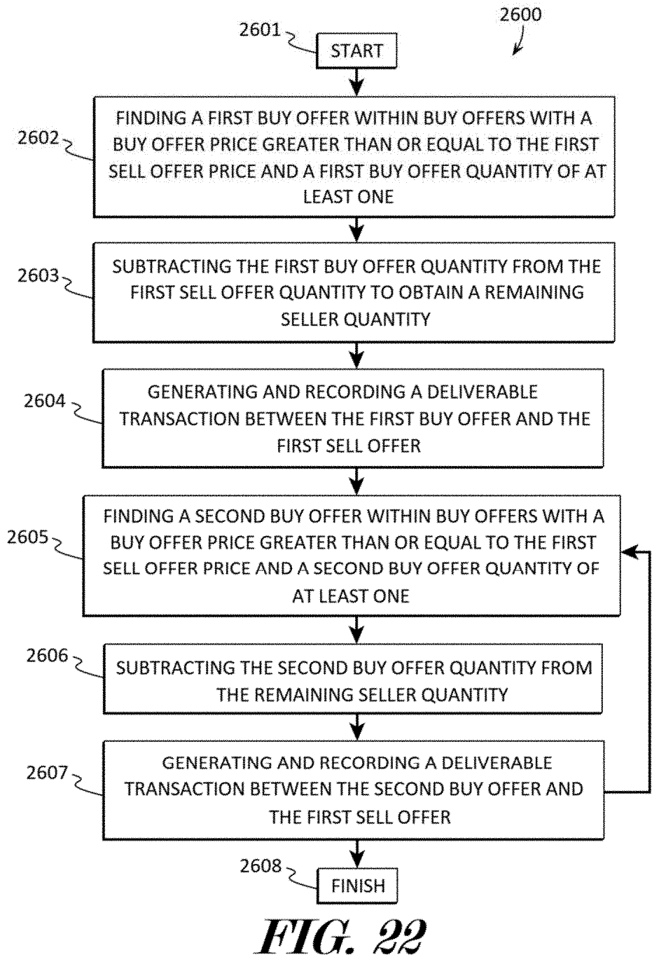

FIG. 22 depicts a block diagram of an example of a computer implemented process for matching a sell offer listing more than one quantity of a deliverable with one or more buy offers (“the method”) 2600 that may be used by the system 100 according to various embodiments. The system 100 may include a system database 120, stored in a data store 308, 408, having a deliverable data record 141 that includes information describing a first deliverable. A plurality of buy offers 144, 148, may be associated with the first deliverable 141 stored in the system database 120, and the plurality of buy offers 144, 148, may have a plurality of buy offer prices 145A, 149A, and a plurality of buy offer quantities 145B, 149B, for the first deliverable 141. For example, the system 100 may have many buy offers 144, 148, for a specific deliverable 141 (product), in this example five buyers 101A, and the buyers 101A may have buy offers 144, 148, having different buy offer quantities 145B, 149B, and different buy offer prices 145A, 149A, such as: Buyer P wants 2 pieces of the deliverable 141 with bid price $14 for each; Buyer Q wants 3 pieces with bid price $13 each; Buyer R wants 1 piece with bid price $12.6 each; Buyer S wants 4 pieces with bid price $11 each; and Buyer T wants 2 pieces with bid price $10 each. In some embodiments, a deliverable 141 of the method 2600 may be: physically or digitally transferred to a first buyer 101A and no longer stored within the system 100; or the deliverable 141 may be stored within the system database 120 or physically stored within a system warehouse 106, and a buyer data record 151 and a seller data record 153 may be updated to reflect the transfer of ownership of the deliverable 141 without having to move the deliverable 141 to the buyer 101A.

A first sell offer (optionally a sell offer 142 or a hidden sell offer 146) may be associated with the first deliverable 141 in the system database 120, and the first sell offer 142, 146, may specify a first sell offer price 143A, 147A, and a first sell offer quantity 143B, 147B, for the first deliverable 141. Continuing the above example, a seller 101B may input a sell offer 142, 146, in which and he wants to sell 10 pieces (sell offer quantity 143B, 147B) with an offer price of $12.50 (sell offer price 143A, 147A). In some embodiments, one or more of the following conditions may be true: the first buy offer price may be for a hidden buy offer 148 and the hidden buy offer price 149A may be hidden and not be displayed by the communication engine 131; the first sell offer price may be for a hidden sell offer 146 and the hidden sell offer price 147A may not be displayed by the communication engine 131; the buyer identifier 152 used for identifying a first buyer 101A may be hidden and not displayed by the communication engine 131; and a seller identifier 154 used for identifying a first seller 101B may be hidden and not displayed and not displayed by the communication engine 131.

The method 2600 may start 2601 and may be performed by an execution engine 132 that may be configured to determine one or more buyers 101A. In step 2602, the execution engine 132 may find a first buy offer 144, 148, within the plurality of buy offer 144, 148, in the system database 120 with (i) a buy offer price 145A, 149A, greater than or equal to the first sell offer price 143A, 147A, and (ii) a first buy offer quantity 145B, 149B, of at least one. Continuing the above example, the $12.5 sell offer price 143A, 147A, is equal to or less than the highest buy offer price 145A, 149A, of $14 from buyer P. Preferably, as the $12.5 is equal to or less than the highest buy offer price 145A, 149A, the execution engine 132 may match the offer of the seller 101B with the highest buy offer price 145A, 149A, of buyer P (for $12.5) so to preferably favor the buyer 101A and give the lowest price of bid and offer price, so they will match for $12.5 not $14.

In step 2603, the execution engine 132 may subtract the first buy offer quantity 145B, 149B, from the first sell offer quantity 143B, 147B, to obtain a remaining seller quantity. A remaining seller quantity may comprise the number or quantity of deliverable that is still required in order to meet or satisfy the sell offer quantity 143B, 147B, of the sell offer 142, 146.

In step 2604, the execution engine 132 may generate and record a deliverable transaction between the first buy offer 144, 148, and the first sell offer 142, 146, when the conditions (i) and (ii) of step 2602 are met. Continuing the above example, the execution engine 132 will match this sell offer 142, 146, with the highest buy offer price 145A, 149A, of buyer P (for $12.5) and match 2 pieces to generate and record a deliverable transaction for the 2 pieces. Then, as the seller 101B wants to sell 10 pieces, the execution engine 132 may modify the sell offer quantity 143B, 147B, of this sell offer 142, 146, from 10 pieces to 8 pieces (after 2 pieces went to Buyer P) with the seller offer price of $12.5. In this example, the remaining seller quantity is 8 and since the remaining seller quantity is 8, the method 2600 may continue and perform steps 2605 to 2607 repeatedly (as needed) until the remaining seller quantity is zero thereby signifying that the sell offer quantity 143B, 147B, of the sell offer 142, 146, has been meet or satisfied or until there is no more buy offer price 145A, 149A in any buy offer 144, 148 that is more than or equal to the sell offer price 143A, 147A, for example buyer S and T mentioned above.

In step 2605, the execution engine 132 may find a second buy offer 144, 148, within the plurality of buy offer 144, 148, with a buy offer price 145A, 149A, greater than or equal to the first sell offer price 143A, 147A, and a second buy offer quantity 145B, 149B, of at least one. Continuing the above example, the execution engine 132 may match the sell offer 142, 146, of the seller 101B with the buy offer 144, 148, of buyer Q having 3 pieces for $12.5 not $13 (as we favor lower price for buyer).

In step 2606, the execution engine 132 may subtract the second buy offer quantity 145B, 149B, from the remaining seller quantity. Continuing the above example, the execution engine 132 may subtract the 3 pieces from the remaining buyer quantity of 8.

In step 2607, the execution engine 132 may generate and record a deliverable transaction between the first sell offer 142, 146, and the second buy offer 144, 148. In preferred embodiments, steps 2605-2607 may be repeated until one of the following conditions is reached (i) the remaining sell offer quantity 143B, 147B, is zero and all of the sell offer quantities are filled, and (ii) a buy offer price 145A, 149A, that is greater than or equal to the first sell offer price 143A, 147A, is not found. Continuing the above example, the execution engine 132 will generate and record a deliverable transaction between the sell offer 142, 146 and the buy offer 144, 148, of buyer Q. The execution engine 132 may repeat steps 2605-2507 as the remaining seller quantity is now 5 pieces with the same bid price of $12.5. The execution engine 132 may repeat step 2605 to again automatically to match the sell offer 142, 146, with another 1 piece from buyer R (for $12.5 not $12.6 as we favor lower price for buyer), repeat the subtraction of step 2606, and repeat the complete a transaction in step 2507. As the seller 101B originally wants to sell 10 pieces so his sell offer is now reduced from 5 pieces (after 2 went to buyer P, 3 went to buyer Q, and 1 went to buyer R) to 4 pieces with the same bid price of $12.5. Now the method 2600 may stop as the next offer from buyer S has a buy offer price 145A, 149A, of $11 which is less than the sell offer price 143A, 147A, so the execution engine 132 will stop at this stage and leave a sell offer 142, 146, in the system 100 for the seller 101B for 4 pieces (sell offer quantity 143B, 147B) at $12.5 (sell offer price 143A, 147A) and the method 2600 may finish 2608.

In some embodiments the system 100, the buy offer price 145A, 149A, of a buy offer 144, 148, may be lowered by the execution engine 132 to the sell offer price 143A, 147A, of a sell offer 142, 146, when the sell offer price 143A, 147A, is less than the buy offer price 145A, 149A. For example, a buy offer 144, 148, for a deliverable 141 may have a buy offer price 145A, 149A, of $50.00 and if there is a sell offer 142, 146, for the deliverable 141 having a sell offer price 143A, 147A, of $45.00, the execution engine 132 may lower the buy offer price 145A, 149A, to $45.00, and may preferably complete a deliverable transaction between the buy offer 144, 148, and the sell offer 142, 146.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or Wi-Fi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer implemented system running on a server computer having a processor for executing a process for matching buy offers with sell offers for the transaction of deliverables, the system comprising:
a system database, stored in a data store, having information describing a first deliverable;
a first sell offer associated with the first deliverable in the system database, the first sell offer provided by a first seller, the first sell offer having a first sell offer price and a first sell offer quantity for the first deliverable;
a first buy offer associated with the first deliverable in the system database, the first buy offer provided by a first buyer, the first buy offer having a first buy offer price and a first buy offer quantity for the first deliverable; and
an execution engine on the server, wherein the execution engine is configured to cause the processor of the server to:
i. compare the first buy offer price and the first buy offer quantity to the first sell offer price and the first sell offer quantity, wherein the system database is further configured to store a sell offer entry date and entry time for each sell offer associated with the first deliverable, the sell offer entry date and entry time for each sell offer associated with the first deliverable used by the execution engine to determine an earliest sell offer received which will be matched with the first buy offer if more than one sell offer prices of more than one sell offers associated with the first deliverable are equal, and wherein the first buy offer price is lowered to the first sell offer price by the execution engine when the first sell offer price is less than the first buy offer price; and
ii. generate and record a deliverable transaction in the system database in which ownership of the first deliverable is transferred to the first buyer when the first buy offer price is greater than or equal to the first sell offer price.

2. The computer implemented system of claim 1, wherein the first deliverable is physically or digitally transferred to the first buyer and no longer stored within the system.

3. The computer implemented system of claim 1, wherein the first deliverable is digitally stored within the system database or physically stored within a system warehouse and wherein a buyer data record and a seller data record are updated to reflect the transfer of ownership of the first deliverable without having to move the first deliverable.

4. The computer implemented system of claim 1, further comprising a second buy offer, the second buy offer linked to the first buy offer, wherein the execution engine cancels the second buy offer upon matching the first buy offer to a sell offer and creating the deliverable transaction.

5. The computer implemented system of claim 1, further comprising a recommendation engine, wherein the recommendation engine is configured to search the internet to find at least one seller for an unmatched deliverable.

6. The computer implemented system of claim 5, wherein the recommendation engine is configured to contact the seller of the unmatched deliverable to solicit a sell offer for the deliverable through the system.

7. The computer implemented system of claim 1, wherein at least one of the following conditions are true:
the first buy offer price is hidden and not displayed to the first seller, and
the first sell offer price is hidden and not displayed to the first buyer.

8. The computer implemented system of claim 1, wherein at least one of the following conditions are true:
a buyer identifier used for identifying the first buyer is hidden and not displayed to the first seller, and
a seller identifier used for identifying the first seller is hidden and not displayed to the first buyer.

9. A computer implemented system running on a server computer having a processor for executing a process for matching buy offers with sell offers for the transaction of deliverables, the system comprising:
a system database, stored in a data store, having information describing a first deliverable;
a first sell offer associated with the first deliverable in the system database, the first sell offer provided by a first seller, and the first sell offer having a first sell offer price and a first sell offer quantity for the first deliverable;
a first buy offer associated with the first deliverable in the system database, the first buy offer provided by a first buyer, and the first buy offer having a first buy offer price and a first buy offer quantity for the first deliverable; and
an execution engine running on the server, wherein the execution engine is configured to cause the processor of the server to:
i. compare the first buy offer price and the first buy offer quantity to the first sell offer price and the first sell offer quantity, and
ii. generate and record a deliverable transaction in the system database in which ownership of the first deliverable is transferred to the first buyer when the first buy offer price is greater than or equal to the first sell offer price, when the first buy offer quantity is equal to or less than the first sell offer quantity, when no other buy offer associated with the first deliverable having a higher buy offer price exists in the system database, and when no other buy offer associated with the first deliverable having an equal price and a date and time prior to the first buy offer exists in the system database.

10. The computer implemented system of claim 9, wherein the first deliverable is physically or digitally transferred to the first buyer and no longer stored within the system.

11. The computer implemented system of claim 9, wherein the first deliverable is digitally stored within the system database or physically stored within a system warehouse and wherein a buyer data record and a seller data record are updated to reflect the transfer of ownership of the first deliverable without having to move the first deliverable.

12. The computer implemented system of claim 9, further comprising a second buy offer, the second buy offer linked to the first buy offer, wherein the execution engine cancels the second buy offer upon matching the first buy offer to a sell offer and creating the deliverable transaction.

13. The computer implemented system of claim 9, further comprising a recommendation engine, wherein the recommendation engine is configured to search the internet to find at least one seller for an unmatched deliverable.

14. The computer implemented system of claim 13, wherein the recommendation engine is configured to contact the seller of the unmatched deliverable to solicit a sell offer for the deliverable through the system.

15. The computer implemented system of claim 9, wherein at least one of the following conditions are true:
the first buy offer price is hidden and not displayed to the first seller or second buyer or second seller, and
the first sell offer price is hidden and not displayed to the first buyer.

16. The computer implemented system of claim 9, wherein at least one of the following conditions are true:
a buyer identifier used for identifying the first buyer is hidden and not displayed to the first seller, and
a seller identifier used for identifying the first seller is hidden and not displayed to the first buyer.

17. The computer implemented system of claim 9, wherein the system database is further configured to store a sell offer entry date and entry time for each sell offer associated with the first deliverable, the sell offer entry date and entry time for each sell offer associated with the first deliverable used by the execution engine to determine an earliest sell offer received which will be matched with the first buy offer if more than one sell offer prices of more than one sell offers associated with the first deliverable are equal, and wherein the first buy offer price is lowered to the first sell offer price by the execution engine when the first sell offer price is less than the first buy offer price.
